(19) United States
(12) Patent Application Publication
(10) Pub. No.: US 2025/0212048 A1
(43) Pub. Date: Jun. 26, 2025

(54) ASSISTANCE TO RAN FOR XR APPLICATIONS

(71) Applicant: InterDigital Patent Holdings, Inc., Wilmington, DE (US)

(72) Inventors: Rocco Di Girolamo, Laval (CA); Michael Starsinic, Newtown, PA (US); Jaya Rao, Montreal (CA); Achref Methenni, Montreal (CA); Saad Ahmad, Montreal (CA)

(73) Assignee: InterDigital Patent Holdings, Inc., Wilmington, DE (US)

(21) Appl. No.: 18/851,851

(22) PCT Filed: Mar. 28, 2023
(86) PCT No.: PCT/US2023/016599

§ 371 Date: Sep. 27, 2024

Related U.S. Application Data
(60) Provisional application No. 63/324,463, filed on Mar. 28, 2022.

(51) Int. Cl. H04W 28/02; H04W 52/02

(52) U.S. Cl. CPC H04W 28/0268; H04W 52/0216

(57) ABSTRACT

Systems, methods, and instrumentalities are described herein for assistance to radio area networks (RAN's) for extended Reality (XR) applications. A wireless transmit/receive unit (WTRU) may be configured to receive a configuration message from a network node. The configuration message may indicate a connected mode discontinuous reception (CDRX) active time duration and may indicate that the CDRX active time duration can be extended, determine uplink extended reality media (XRM) data to be sent to the network node. The WTRU may determine a length of time for extending the CDRX active time duration based on a property of the uplink XRM data. The WTRU may send assistance information to the network node. The assistance information may indicate a request to extend the CDRX active time duration by the length of time.

### CROSS-REFERENCE TO RELATED APPLICATIONS

This application claims the benefit of Provisional U.S. Patent Application No. 63/324,463, filed Mar. 28, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for assistance to radio area networks (RANs) for extended Reality (XR) applications.

A wireless transmit/receive unit (WTRU) may be configured to receive a configuration message from a network node. The configuration message may indicate a connected mode discontinuous reception (CDRX) active time duration (e.g., first CDRX active time duration) and may indicate that the CDRX active time duration can be extended. The WTRU may determine uplink data (e.g., uplink extended reality media (XRM) data) to be sent to the network node. The WTRU may determine a length of time for extending the first CDRX active time duration based on a property of the uplink XRM data. The WTRU may send assistance information to the network node. The assistance information may indicate a request to extend the first CDRX active time duration by the length of time. The WTRU may receive a confirmation message from a network node. The confirmation message may indicate a second CDRX active time duration. The WTRU may receive (e.g., monitor) a physical downlink control channel (PDCCH) transmission during the second CDRX active time duration.

In examples, the second CDRX active time duration may be equal to the first CDRX active time duration extended by the requested length of time or a different CDRX active time duration than the first CDRX active time duration extended by the requested length of time. The second CDRX active time duration may be measured relative to one or more of: a number of CDRX cycles, a duration in ms, a duration in symbols, a duration in slots, a duration in subframes, a duration in frames, a start of another CDRX cycle, or a time duration indicated by the WTRU.

In examples, the property of the uplink data may indicate that the uplink data includes uplink pose information. The property of the uplink data may indicate a motion-to-photon (MTP) parameter or a total round trip time parameter. In examples, the MTP parameter or the total round trip time parameter may be based on a configured MTP latency requirement. In examples, the MTP parameter or the total round trip time parameter may be based on header information included with the uplink data. In examples, the length of time for extending the first CDRX active time duration may be determined based on a difference between the MTP parameter and a time remaining in the first CDRX active time duration.

In examples, the WTRU may be further configured to receive downlink XRM data from the network during the extended CDRX active time duration, wherein the downlink XRM data is received in response to the uplink data. The WTRU may be further configured to send the uplink data to the network node during the second CDRX active time duration.

A network node may be configured to determine an uplink packet delay budget (PDB) value associated with a first quality of service (QOS) flow and a downlink PDB value associated with a second QoS flow. The uplink PDB value and the downlink PDB value may be equal. The network node may determine a packet delay for the first QoS flow and the second QoS flow. The network node may adjust the uplink PDB value and the downlink PDB value based on the packet delay. The network node may modify at least one of a QoS profile, a QoS rule, or a service data flow (SDF) template based on the adjustment.

In examples, based on the packet delay obtained for the first QoS and the second QoS flow, the network node may determine the uplink PDB value is too low. Based on the uplink PDB value being too low, the network node may increase the uplink PDB value and decrease the downlink PDB value. In examples, based on the packet delay obtained for the first QoS and the second QoS flow, the network node may determine the uplink PDB value is too high. Based on the uplink PDB value being too high, the network node may decrease the uplink PDB value and increase the downlink PDB value. In examples, based on the packet delay obtained for the first QoS and the second QoS flow, the network node may determine the downlink PDB value is too low. Based on the downlink PDB value being too low, the network node may decrease the uplink PDB value and increase the downlink PDB value. In examples, based on the packet delay obtained for the first QoS and the second QoS flow, the network node may determine the downlink PDB value is too high. Based on the downlink PDB value being too high, the network node may increase the uplink PDB value and decrease the downlink PDB value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of energy consumption for different WTRU activities.

FIG. 3 illustrates an example of DRX cycles. CDRX parameters may be used to configure a short CDRX cycle and/or a long CDRX cycle.

FIG. 4 illustrates an example of a virtual reality (VR) use case.

FIG. 5 illustrates an example of CDRX timing.

FIG. 6 illustrates an example of CDRX jitter.

FIG. 7 illustrates an example of a frame size.

FIG. 8 illustrates an example of an uplink/downlink (UL/DL) coordination.

FIG. 9 illustrates an example of one or more objectives to save power.

FIG. 10 illustrates an example of power savings for a WTRU.

FIG. 11 illustrates an example of transmission options for assistance information from a WTRU.

FIG. 12 illustrates an example of linked quality of service (QOS) flows for extended Reality (XR)/media services.

FIG. 13 illustrates an example of linked QoS flows using one or more QoS Flow Id (QFI) lists.

FIG. 14 illustrates an example of a WTRU configured to periodically change the start offset time for a CDRX for aligning with data reception based on the frame rate applied for the data.

FIG. 15 illustrates an example of a WTRU changing the on/active time duration in subsequent CDRX cycles when detecting a triggering event during a CDRX cycle.

### DETAILED DESCRIPTION

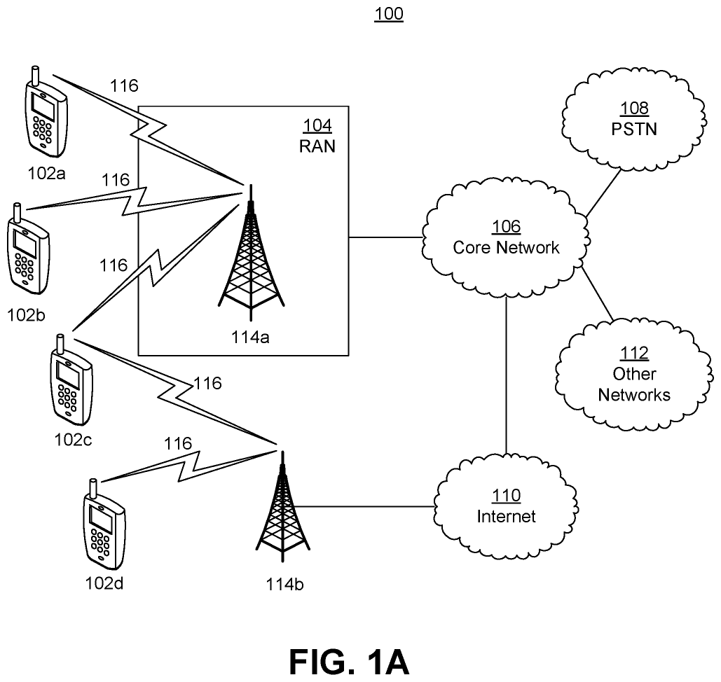

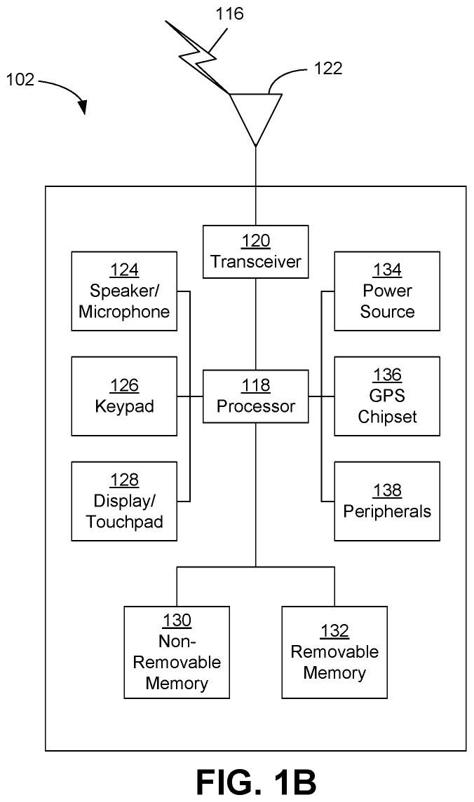

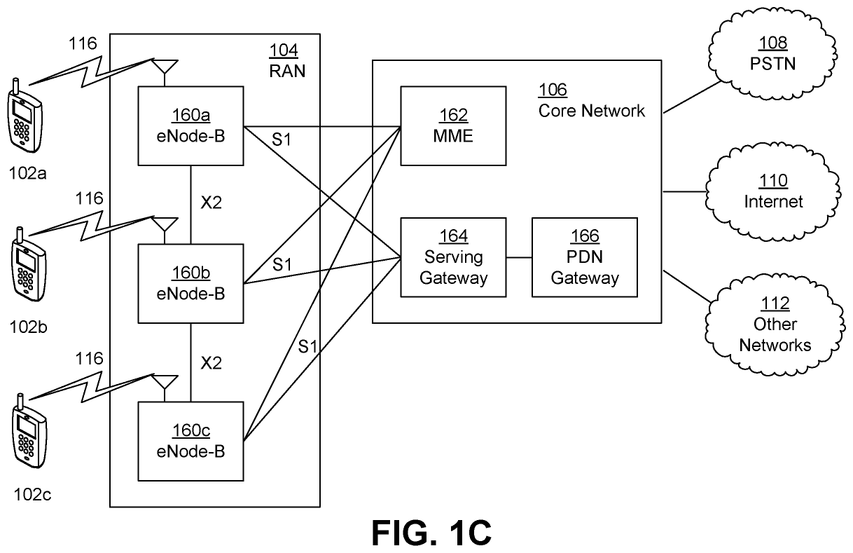

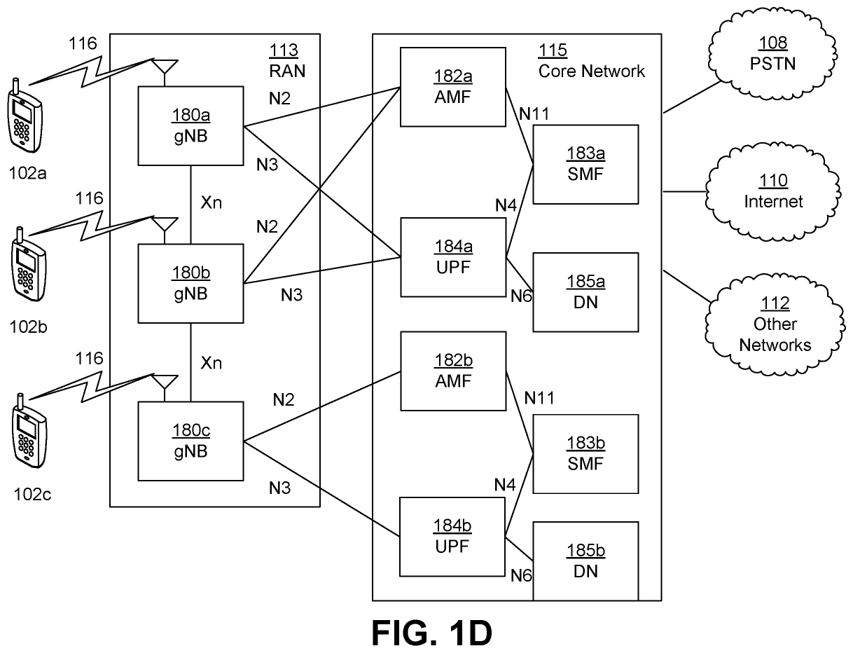

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b. 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000. WIMAX, E-UTRA, or WiFi radio technology.

The CN 106/115 may also serve as a gateway for the WTRUs 102a, 102b, 102c. 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b. 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHz, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac. 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a. 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a. 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b. 160c may serve as a mobility anchor for WTRUs 102a. 102b, 102c and gNBs 180a, 180b, 180c may provide additional coverage and/or throughput for servicing WTRUs 102a, 102b, 102c.

Each of the gNBs 180a. 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a. 182b may be connected to one or more of the gNBs 180a, 180b, 180c in the RAN 113 via an N2 interface and may serve as a control node. For example, the AMF 182a. 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to the determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Reference to specific I, B, and P frame types for video transmission herein, are exemplary frame types. I frames may be understood as frame types that are reference frames. Reference frames may be frames of a compressed video that are used to define future frames. Reference frames may rely on intra-frame compression techniques. B and P frames may be understood as non-reference frames, that may rely on inter-frame coding with reference frames. P frames may be coded from prior I and/or P frames. B frames may be coded from prior or future I frames

Systems, methods, and instrumentalities are described herein for assistance to radio area networks (RANs) for extended Reality (XR) applications.

A wireless transmit/receive unit (WTRU) may be configured to receive a configuration message from a network node. The configuration message may indicate a connected mode discontinuous reception (CDRX) active time duration (e.g., first CDRX active time duration) and may indicate that the CDRX active time duration can be extended. The WTRU may determine uplink data (e.g., uplink extended reality media (XRM) data) to be sent to the network node. The WTRU may determine a length of time for extending the first CDRX active time duration based on a property of the uplink XRM data. The WTRU may send assistance information to the network node. The assistance information may indicate a request to extend the first CDRX active time duration by the length of time. The WTRU may receive a confirmation message from a network node. The confirmation message may indicate a second CDRX active time duration. The WTRU may receive (e.g., monitor) a physical downlink control channel (PDCCH) transmission during the second CDRX active time duration.

In examples, the second CDRX active time duration may be equal to the first CDRX active time duration extended by the requested length of time or a different CDRX active time duration than the first CDRX active time duration extended by the requested length of time. The second CDRX active time duration may be measured relative to one or more of: a number of CDRX cycles, a duration in ms, a duration in symbols, a duration in slots, a duration in subframes, a duration in frames, a start of another CDRX cycle, or a time duration indicated by the WTRU.

In examples, the property of the uplink data may indicate that the uplink data includes uplink pose information. The property of the uplink data may indicate a motion-to-photon (MTP) parameter or a total round trip time parameter. In examples, the MTP parameter or the total round trip time parameter may be based on a configured MTP latency requirement. In examples, the MTP parameter or the total round trip time parameter may be based on header information included with the uplink data. In examples, the length of time for extending the first CDRX active time duration may be determined based on a difference between the MTP parameter and a time remaining in the first CDRX active time duration.

In examples, the WTRU may be further configured to receive downlink XRM data from the network during the extended CDRX active time duration, wherein the downlink XRM data is received in response to the uplink data. The WTRU may be further configured to send the uplink data to the network node during the second CDRX active time duration.

A network node may be configured to determine an uplink packet delay budget (PDB) value associated with a first quality of service (QOS) flow and a downlink PDB value associated with a second QOS flow. The uplink PDB value and the downlink PDB value may be equal. The network node may determine a packet delay for the first QoS flow and the second QoS flow. The network node may adjust the uplink PDB value and the downlink PDB value based on the packet delay. The network node may modify at least one of a QoS profile, a QoS rule, or a service data flow (SDF) template based on the adjustment.

In examples, based on the packet delay obtained for the first QoS and the second QoS flow, the network node may determine the uplink PDB value is too low. Based on the uplink PDB value being too low, the network node may increase the uplink PDB value and decrease the downlink PDB value. In examples, based on the packet delay obtained for the first QoS and the second QoS flow, the network node may determine the uplink PDB value is too high. Based on the uplink PDB value being too high, the network node may decrease the uplink PDB value and increase the downlink PDB value. In examples, based on the packet delay obtained for the first QoS and the second QoS flow, the network node may determine the downlink PDB value is too low. Based on the downlink PDB value being too low, the network node may decrease the uplink PDB value and increase the downlink PDB value. In examples, based on the packet delay obtained for the first QoS and the second QoS flow, the network node may determine the downlink PDB value is too high. Based on the downlink PDB value being too high, the network node may increase the uplink PDB value and decrease the downlink PDB value.

Assistance information may be provided by a WTRU to assist a network. The assistance information may be used by the network or by the WTRU, to select between one or more connected mode discontinuous reception (CDRX) configurations. The assistance information may be used by the network, or by the WTRU to minimize wasteful over-the-air transmissions. Assistance information may be provided by the user plane function (UPF), the access stratum (AS), or the network data analytics function (NWDAF) to assist the network in optimizing CDRX configurations. Mechanisms to signal the assistance information from the WTRU to the network may be provided. PDU headers (e.g., new PDU headers) in quality of service (QOS) flows may enable the assistance information to be sent between the WTRU and the network.

Mechanisms to link QoS flows may be provided. Mechanisms may be provided to deal with stringent round trip time (RTT) requirements for linked QoS flows may be provided. Mechanisms to determine when to transmit uplink (UL) traffic based on transmission (e.g., preferred transmission) occasions and QoS characteristics of a QoS flow. Mechanisms may be provided for the WTRU to change the CDRX configuration based on one or more metrics or events. Mechanisms may be provided for the WTRU to select a CDRX configuration (e.g., a new CDRX configuration) based on one or more metrics or events.

Examples of CDRX may be provided herein. A WTRU (e.g., typical WTRU) may be involved with activities (e.g., several activities) during its normal operation. The activities may be divided into broad categories, such as the following five broad categories: deep sleep; periodic activities in idle mode; periodic activities in connected mode; data transmission and reception; and control channel monitoring (e.g., while in connected mode or while in connected mode during the CDRX active time duration(s)). In examples, control channel monitoring may refer to the activity where the WTRU may not be involved in any uplink or downlink data transmission, but may be monitoring the control channel, such as the PDCCH transmission, to receive DCI from the RAN node. In examples, control channel monitoring may refer to receiving a PDCCH transmission during the extended active time duration. Examples of the DCI include DL and/or UL scheduling information. Power consumption studies show that a WTRU may consume a great deal of power during this latter activity.

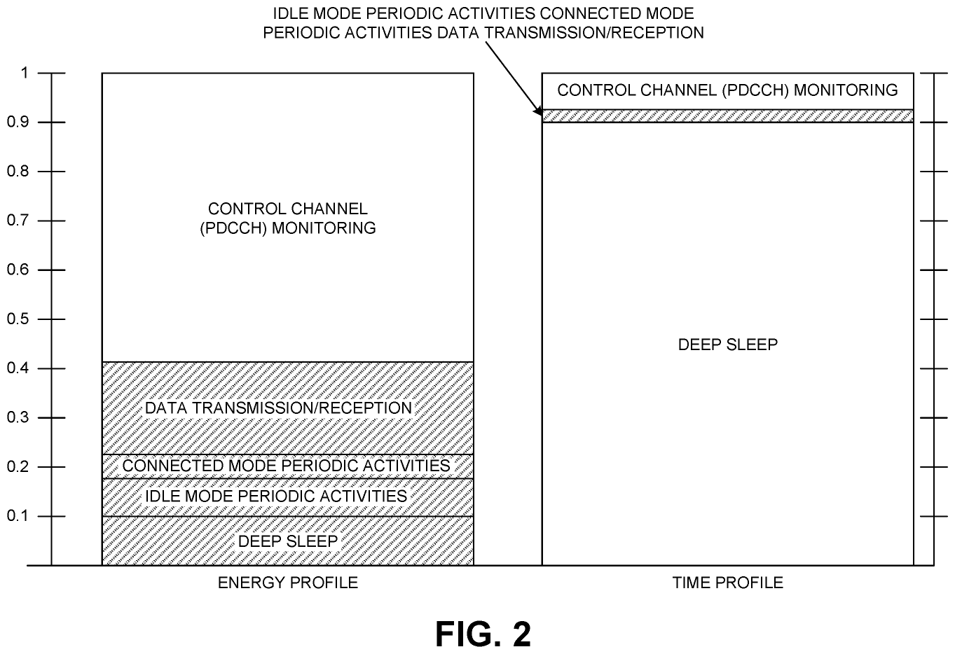

FIG. 2 illustrates an example of energy consumption for different WTRU activities. As shown in FIG. 2, the control channel monitoring may be responsible for about 55% of the WTRU power consumption (even though it may account for less than 10% of the activities of a WTRU). To address this power consumption, the network may configure connected mode DRX for a WTRU. The CDRX may control when the WTRU stops PDCCH monitoring (e.g., to save power). CDRX may have an ON-OFF cycle, during which the WTRU may monitor the PDCCH during the ON duration(s), and where the WTRU may stop monitoring the PDCCH during the OFF duration(s). The network may indicate that the WTRU may not be sent a DCI during the WTRU's OFF duration. The ON duration of the cycle, also known as the active time, may be variable. The ON duration of the cycle may be extended based on UL or DL activity. For some technologies, such as NR, the WTRU support for CDRX may be requested, but the activation and configuration of the WTRU may be controlled by the RAN node through RRC signaling. If a RAN node configures CDRX, it may be considered active, and the WTRU may follow CDRX for power savings.

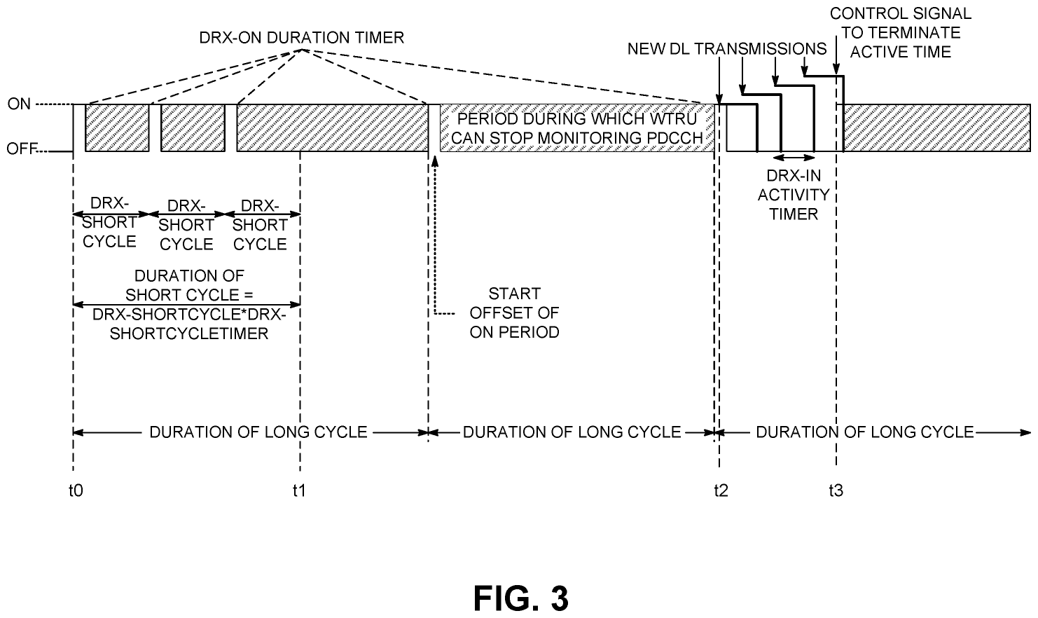

FIG. 3 illustrates an example of discontinuous reception (DRX) cycles. CDRX parameters may be used to configure a short CDRX cycle and a long CDRX cycle. The start times of the ON periods of a long CDRX cycle and the periodicity of these ON periods may be controlled by a configurable parameter (drx-LongCycleStartOffset) (shown as “Start offset of ON period” and “Duration of Long Cycle” in FIG. 3). The configurable parameter “Start offset of ON period” may allow the RAN node to spread out, in time, the ON periods of different WTRUs. This may provide the RAN node some flexibility in scheduling these different WTRUs. The short CDRX cycle may have a maximum duration, controlled by a short cycle timer. If the short cycle timer expires, the long cycle may be used (e.g., as shown in FIG. 3 between times t0 and t1).

The ON periods may be provided by the CDRX parameter drx-onDuration Timer. If (e.g., at any time) the WTRU is monitoring the DCI and it receives a DL transmission (e.g., a new DL transmission), the WTRU may start or restart an inactivity timer (drx-Inactivity Timer). The inactivity timer may be associated with a duration of time. The duration of time associated with the inactivity timer may extend the WTRU's active duration of time (e.g., active time as shown in FIG. 3 at time t2). The extended active duration of time (e.g., an extended active time) may allow the WTRU to be awake to receive any potential retransmissions. The extended active time may (e.g., may also) allow the RAN node some flexibility in sending additional transport blocks to the WTRU (e.g., as it may be likely that the RAN node has more than one transport block awaiting transmission to the WTRU). If an active time is extended, the subsequent cycle may start as a short CDRX cycle if the short CDRX cycle is configured. The subsequent cycle may (e.g., may alternatively) start as a long CDRX cycle.

The configuration of the CDRX parameters may allow the RAN node to tradeoff WTRU power savings against latency. In examples, CDRX parameters resulting in large OFF periods may provide the WTRU with significant power savings. However, if a RAN node happens to miss the WTRU active time, the RAN node may wait until the next active time to communicate with the WTRU. If the CDRX parameters (e.g., in contrast) are configured to result in large active times, the RAN node may (e.g., more easily) communicate with the WTRU. However, the power savings gains may be minimized. In such cases, if the RAN node knows that no additional communication to the WTRU is pending, the RAN node may send a control message to the WTRU during the WTRU's active time. This control message may tell the WTRU to cut short the active time and immediately go to an OFF period. This may be achieved through a MAC CE (e.g., as shown in FIG. 3 at time t3).

CDRX may be a MAC procedure and may be considered a property of a WTRU. CDRX may not be related to any specific data radio bearer (DRB) or signaling radio bearer (SRB) that may be configured for the WTRU. CDRX may apply to configured DRBs and SRBs (e.g., to all configured DRBs and SRBs). Configured CDRX parameters may not be coupled (e.g., tightly coupled) to the characteristics of the traffic to and from the WTRU.

Serving cells of a MAC entity may be configured by an RRC in DRX groups (e.g., two DRX groups) with DRX parameters (e.g., separate DRX parameters). If DRX groups (e.g., two DRX groups) are configured, each serving cell may be assigned (e.g., uniquely assigned) to either of the groups (e.g., two groups).

In addition to the ON/OFF pattern (e.g., as described in FIG. 3), there may be an opportunity for micro-sleep periods. In examples, after a WTRU receives a transport block but fails to decode this transport block, the WTRU may ask for a retransmission. There may be a delay before the gNB can send the retransmission. During this delay, the WTRU may go into micro-sleep. The micro-sleep may be governed by timers (e.g., two additional timers, such as a hybrid automatic repeat request (HARQ) RTT timer and a HARQ retransmission timer).

Table 1 below shows the possible values of the configurable CDRX parameters:

| | |
|---|---|
| drx-onDurationTimer | 1/32, 2/32 , . . . , 31/31, 1, 2, 3, 4, 5, 6, 8, 10, 20, 30, 40, 50, 80, 100, 200, |
| | 300, 400, 500, 600, 800, 1000, 1200, 1600 in msec |
| drx-InactivityTImer | 0, 1, 2, 3, 4, 5, 6, 8, 10, 20, 30, 40, 50, 80, 100, 200, 300, 500, 750, |
| | 1280, 1920, 2560 in msec |
| Duration of Long Cycle | 10, 20, 32, 40, 60, 64, 70, 80, 128, 160, 256, 320, 512, 640, 1024, |
| | 1280, 2048, 2560, 5120, 10240 in msec |
| Start offset of ON period | Any time within the Long Cycle |
| Duration of Short Cycle | 2, 3, 4, 5, 6, 7, 8, 10, 14, 16, 20, 30, 32, 35, 40, 64, 80, 28, 160, 256, |
| | 320, 512, 640 in msec |
| Short Cycle Timer | Multiple of short cycle (from 1 to 16 times the Short Cycle) |

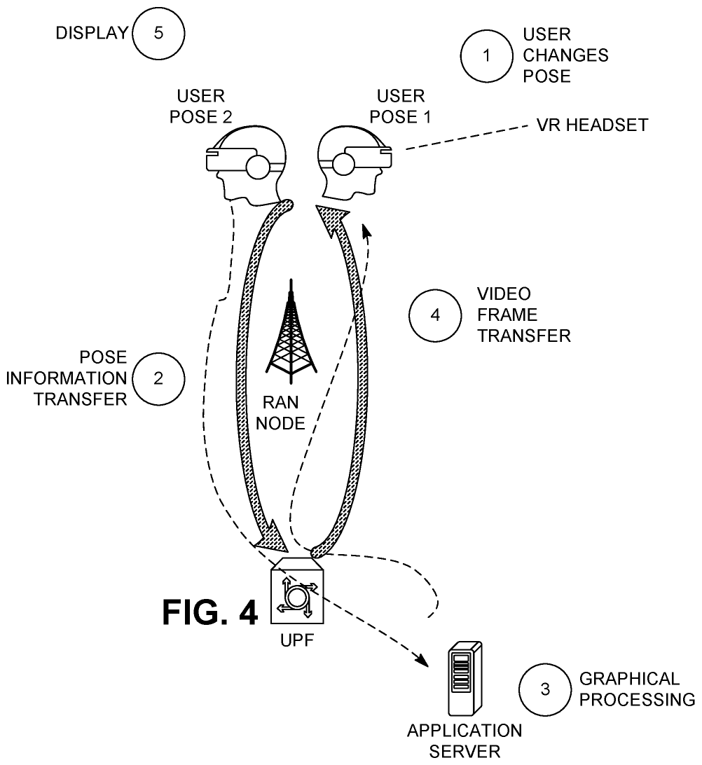

FIG. 4 illustrates an example of a virtual reality (VR) use case. Examples of use cases and typical media characteristics may be provided herein. In a VR use case (e.g., as shown in FIG. 4), where the WTRU may be a VR headset and where the video feed for the VR headset may be provided by an application server, communication to and from the VR headset may be via a network (e.g., a 5G network).

An example of a VR use case is described as follows: A user may change pose. In examples, the user may turn his or her head. Pose information may be captured by sensors. Pose information may be sent as UL information to the application server. The application server may process the pose information and generate VR information (e.g., new VR information) for the headset. The VR information generated by the application server may include both video frames and audio frames. The application server may (e.g., may also) generate other user plane data. The video frames, audio frames, and user plane data may be sent as downlink information to the VR headset. The VR headset may process video frames and audio frames, which may be provided to the user.

In example use cases, the VR headset may request and/or use both uplink and downlink transmission. Example characteristics of traffic in VR use cases may be one or more of the following:
Uplink pose information: Usually small, but periodic (e.g., every 4 msec).
Downlink video information: Mostly composed of video frames. The frame rate may depend on quality (e.g., 60/90/120 frames per second (fps)). The size of the frames may be variable and may be very large. The importance of the frame may be variable—that is some video frames may be more important than other video frames.
Downlink audio information: typically periodic (e.g., every 20 msec) with little variability in size, and usually small.

In some cases (e.g., a change of pose information), the DL transmission may be triggered by an UL transmission. For the end user to have a good QoE, there may be a latency requirement between the physical movement of a user's head, which may result in a change in pose information (sometimes referred to as motion) and the updated picture in the VR headset (sometimes referred to as photon). There may (e.g., may also) be a latency requirement (e.g., similarly) between the physical movement of a user's head (motion) and the updated sound waves from a head-mounted speaker reaching the end user's ears (sometimes referred to as ‘sound’). Example characteristics may be one or more of the following: motion-to-photon latency in the range of 7 ms to 15 ms while maintaining the required resolution of up to 8K, giving user data rate of up to [1 Gbit/s]; and motion-to-sound latency of [<20 ms].

Examples of QoS may be provided (e.g., QoS in 5GS). In examples (e.g., in 5GS), the granularity of the QoS may be applied per QoS flow. The QoS flow may be the lowest level of granularity within the system (e.g., the 5G system) and may be where policy and charging are enforced. QoS parameters and characteristics may be tied to a QoS flow. Each QoS flow may be identified by a QFI, which may be unique within a packet data unit (PDU) session. The RAN node may establish a DRB per, QoS flow or the RAN node may combine more than one QoS flow into the same DRB. One or more SDFs, for example, an IP flow, may be mapped to a QoS flow. Traffic (e.g., all traffic) within the same QoS flow may receive the same treatment.

QoS characteristics of a QoS flow may include the packet data budget (PDB) and the packet error rate (PER). The PDB may provide (e.g., define) an upper bound when a packet may be delayed between the WTRU and the user plane function (UPF). The PER may provide (e.g., define) an upper bound for the rate of PDUs (e.g., IP packets) that have been processed by the sender of a link layer protocol but that are not successfully delivered by the corresponding receiver to the upper layer.

Power saving improvements may be provided. CDRX may be a static configuration procedure. The WTRU may be configured with a single DRX configuration for a serving cell, with an ON cycle, timers, etc. This static configuration may not be suitable for XR/media services. This may result in at least four issues: a timing issue, a jitter issue, a frame size issue, and an UL/DL coordination issue. Enhancements may be necessary to provide assistance to the RAN nodes, to minimize the impact of these issues, and maximize the power savings for XR/media services.

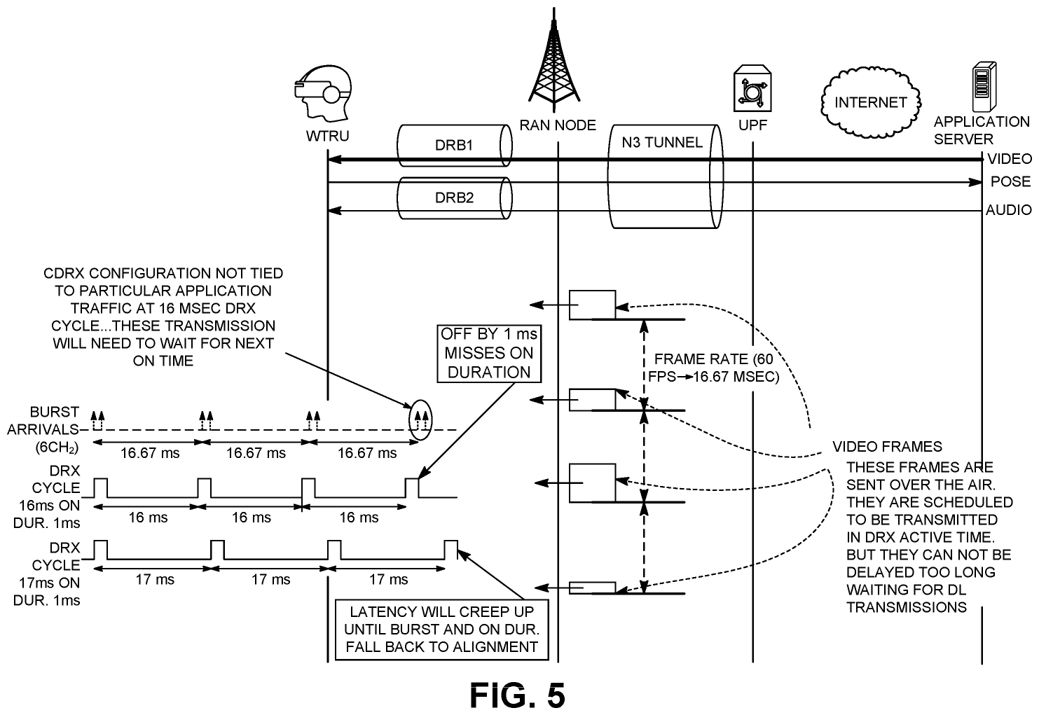

FIG. 5 illustrates an example of CDRX timing. Improvements for addressing CDRX timing may be provided herein. FIG. 5 shows a VR headset use case, with three service data flows (pose, video, and audio). The RAN node may map these flows to one or more DRBs. In examples (e.g., in FIG. 5), it may be assumed that the video frame rate is 60 frames per second (fps), which may result in a video frame arriving at the RAN node about every 16.67 msec. The RAN node may try to match the DRX cycle to this frame rate (e.g., to help avoid video frame delays). However, Table 1 shows that there may not be a DRX cycle that may match this frame rate. As the granularity of the DRX cycle is per msec, DRX cycles of 16 msec or 17 msec may be defined, but these DRX cycles may result in certain frames arriving at the RAN node outside the WTRU's active time. These video frames may be delayed until the subsequent active time. Note that although shown for 60 fps, the same issue may occur with a frame rate of 90 fps and 120 fps.

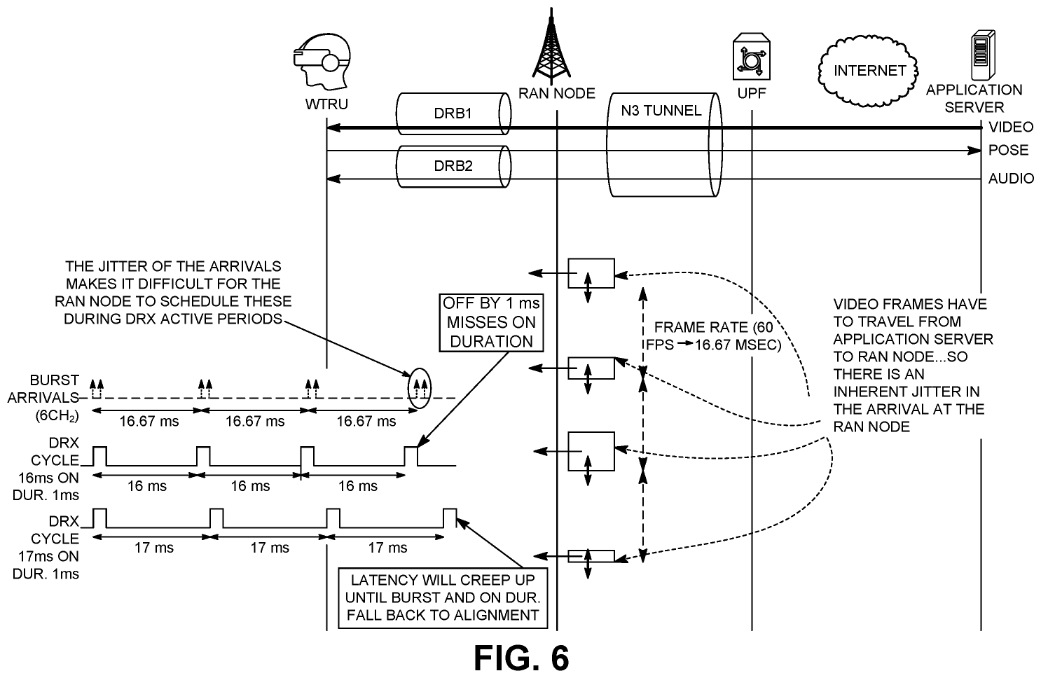

FIG. 6 illustrates an example of CDRX jitter. Improvements for addressing the CDRX jitter may be provided herein. FIG. 6 shows the VR headset use case (e.g., the same VR headset use case) with three service data flows (pose, video, and audio) and a frame rate of 60 fps. The video frames may travel over the data network, from the application server to the UPF, and over (e.g., then over) the transport network, from the UPF to the RAN node. As a result, there may be an inherent jitter in the arrival of video frames at the RAN nodes. Some video frames may have an inter-frame timing of less than 16.67 msec, while other video frames may have an inter-frame timing greater than 16.67 msec. Even if the CDRX cycle matches the video frame rate, this jitter may mean that some video frames may arrive early, while others may arrive late. For the latter case, the video frame may be delayed (e.g., may need to be delayed) and wait for the next active time.

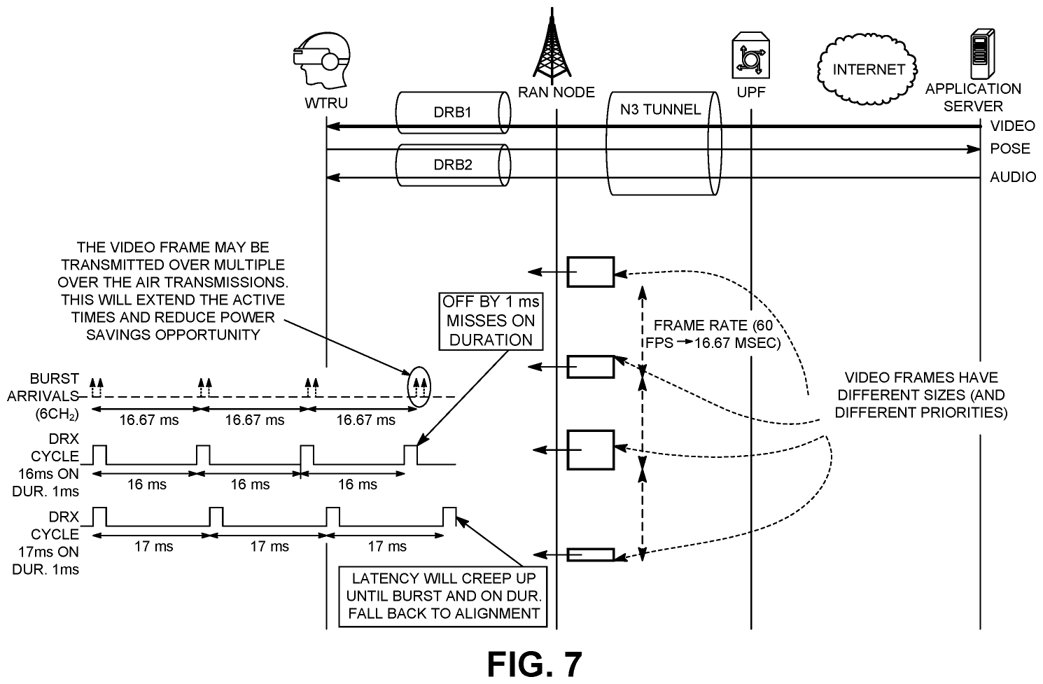

FIG. 7 illustrates an example of a frame size. Improvements for addressing the frame size may be provided herein. FIG. 7 shows the VR headset use case (e.g., the same VR headset use case), with three service data flows (pose, video, and audio) and a frame rate of 60 fps. The video frames may be quite large and may be of different sizes and importance. The RAN node may send these frames over the air interface over multiple over-the-air transmissions. These transmissions (e.g., each of these transmissions) may trigger the WTRU's inactivity timer and extend the WTRU's active time. Extending the WTRU active time may result in a smaller power savings opportunity (e.g., as the DRX cycle is expected to be relatively short to match the frame rate).

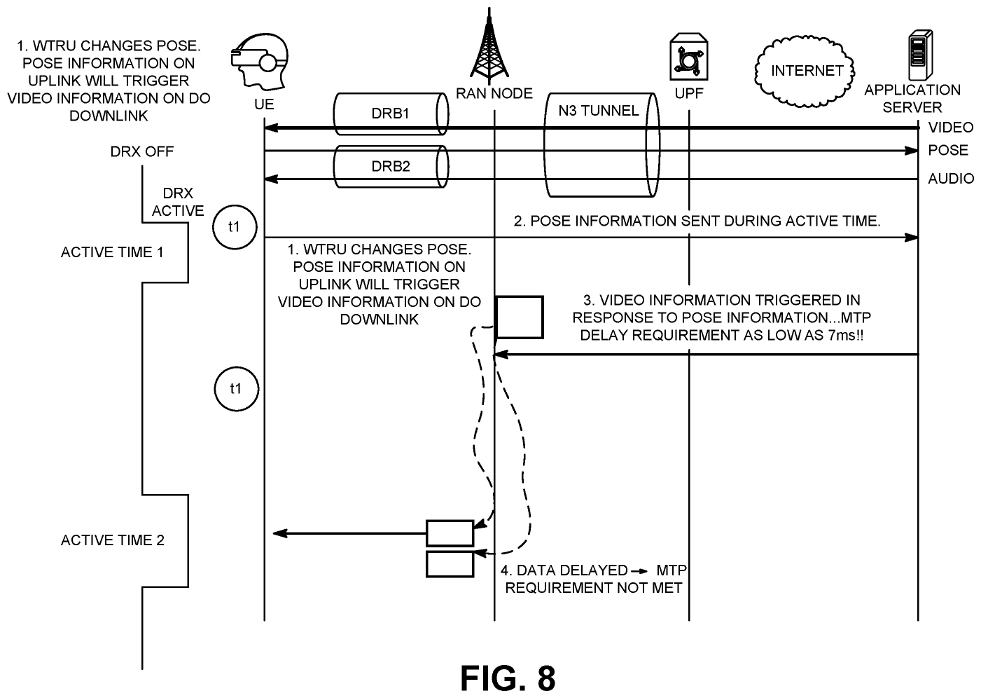

FIG. 8 illustrates an example of a UL/DL coordination. Improvements for addressing the UL/DL coordination may be provided herein. FIG. 8 shows the VR headset use case (e.g., the same VR headset use case) with three service data flows (e.g., pose, video, and audio) and a frame rate of 60 fps. At time t1, the user may turn his or her head, which may result in pose information being sent to the application server. This transmission may occur in active time 1. The application server may respond with the updated video frame, which may arrive at the RAN node at time t2. This video frame may be (e.g., may need to be) delayed to the next active time (e.g., as the WTRU is no longer in active time). In examples, the time between the motion (e.g., sending the pose information) and the photon (e.g., displaying the updated video frame) may be larger than the motion-to-photon requirement for these applications.

How service data flows are mapped to QoS flows for XR/media Services may be (e.g., may need to be) defined. An XR/media service may be made up of multiple service data flows. The service data flows may be mapped to a number of QoS flows (e.g., based on the treatment expected for these service data flows). QoS characteristics (e.g., new QoS characteristics) may be (e.g., may need to be) defined for the XR/media services SDFs that are mapped to QoS flows. The service data flows of an XR/media service may be tightly coupled (e.g., in addition). In examples, an UL service data flow carrying pose information may be linked to a downlink service data flow carrying video frame information or audio frame information. QoS characteristics (e.g., new QoS characteristics) may be (e.g., may need to be) defined to address these linked QoS flows. The behavior of the WTRU and the network may be (e.g., may need to be) defined if a QoS requirement of one of the linked flows is not met.

Improvements regarding the UL active time may be provided. A WTRU may have many reasons for sending UL traffic. This may include user plane data (e.g., pose information), scheduling requests, CSI reports, HARQ ACK, buffer status reports, power headroom reports, etc. The independent transmission occasion of these forms (e.g., each of these forms) of UL traffic may limit the sleep time at the WTRU. It has been proposed that the transmission of UL signals/data may be confined within a period of time (referred to as UL active time). In so doing, the WTRU is more likely to go to a deeper sleep. Enhancements may be necessary to provide assistance to the RAN nodes, so that the UL active time can be efficiently configured.

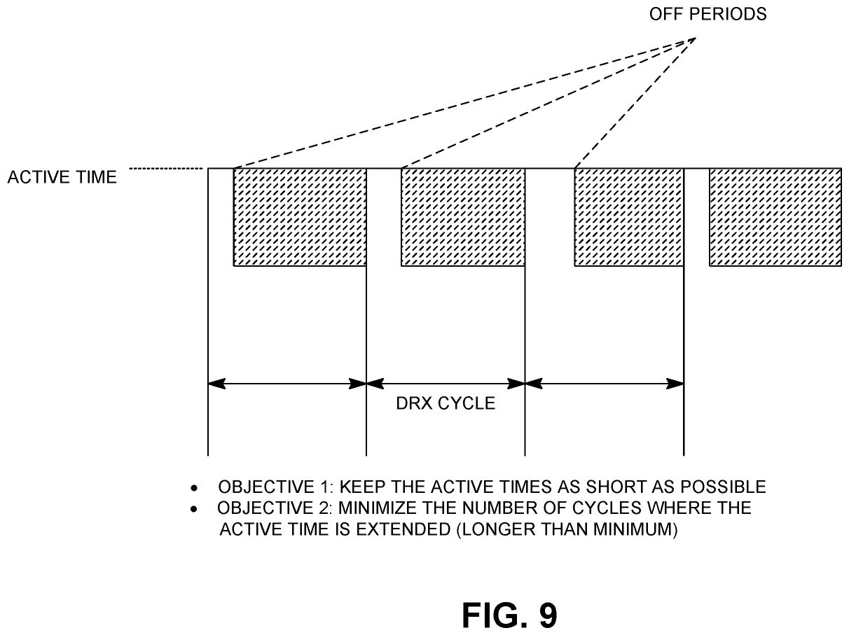

FIG. 9 illustrates an example of objectives to save power. The basic CDRX cycle may be divided between ON periods (or active times) and OFF periods. Objectives to maximize the power savings may be to keep the active times as short as possible and minimize the number of cycles in which the active time is extended (e.g., as shown in FIG. 9). In order to achieve these objectives, one or more of the following may be proposed: assistance information provided by the WTRU to assist the network; assistance information provided by the UPF to assist the network in optimizing CDRX configurations; mechanisms to signal the assistance information from the WTRU to the network; PDU headers (e.g., new PDU headers) in QoS flows to enable the assistance information to be sent between the WTRU and the network; mechanism to link QoS flows; mechanisms to deal with stringent RTT requirements for linked QoS flows; mechanisms to determine when to transmit UL traffic based on transmission occasions (e.g., preferred transmission occasions) and QoS characteristics of a QoS flow; or mechanisms for the WTRU to change the CDRX configuration or select a CDRX configuration (e.g., a new CDRX configuration) based on one or metrics or events.

Regarding assistance information that the WTRU may provide to assist the network, examples of assistance information may include one or more of the following: power status, Group of Picture (GOP) structure, extension of active time, or which QoS flows are linked. In examples, the assistance information may be used by the network to optimize the CDRX configuration. In examples, the assistance information may be used by the WTRU to select between one or more CDRX configurations. In examples, the assistance information may be used to minimize wasteful over-the-air transmissions. Wasteful over-the-air transmissions may refer to PDU transmissions over the wireless interface (between WTRU and the RAN node) that are not necessary or mismatched/misaligned with respect to the CDRX configuration used by the WTRU. In examples, the WTRU may have failed the reception of a video I-frame. There may not be a need for the WTRU to receive any future video P-frames that rely on this I-frame as a reference (e.g., in this case).

Assistance information may be provided. For example, assistance information may be provided by the UPF to assist the network in optimizing CDRX configurations. Mechanisms to signal the assistance information from the WTRU to the network may be provided. PDU headers in QoS flows may be provided, which may enable the assistance information to be sent between the WTRU and the network. Mechanisms to link QoS flows may be provided. Mechanisms to deal with stringent RTT requirements for linked QoS flows may be provided. Mechanisms may be provided to determine when to transmit UL traffic based on preferred transmission occasions and QoS characteristics of a QoS flow. Mechanisms may be provided for the WTRU to change the CDRX configuration or select a CDRX configuration based on one or more metrics or events.

PDUs associated with a single video frame may be referred to as a burst set or a burst of PDUs. These PDUs may arrive as a burst to the UPF, or they may be generated as a burst at the WTRU. These PDUs may need to be (e.g., may need to all be) correctly received at the WTRU or UPF. If the PDUs are not correctly received at the WTRU or UPF, the video frame they are trying to convey may not be correctly rendered. The notion may be described in terms of a video frame, but it may apply to any burst of PDUs that may need to be (e.g., need to all be) received correctly to be useful. These PDUs are (e.g., are also) sometimes referred to as a PDU set. A PDU set may be composed of one or more PDUs carrying the payload of one unit of information generated at the application level (e.g., a frame or video slice for XRM services), which may be of the same importance requirement at the application layer. PDUs (e.g., all PDUs) in a PDU set may be needed by the application layer to use the corresponding unit of information. In examples, the application layer may (e.g., may still) recover parts of the information unit if some PDUs are missing.

The terms application server and application function may be used interchangeably. Examples of power savings may be provided. In examples, the RAN node may be provided assistance information to allow the RAN node to do one or more of the following: configure CDRX parameters to match the XR/media service traffic better; dynamically alter the CDRX parameters as conditions change for the transmission and reception of the XR/media service traffic; or provide multiple CDRX configurations to the WTRU, with each configuration tailored to specific conditions for the transmission and reception of the XR/media service traffic. These conditions typically refer to events that are monitored at the WTRU and that may be impacted by CDRX (e.g., a WTRU moving from battery power to mains/wall power). Further example conditions are described below.

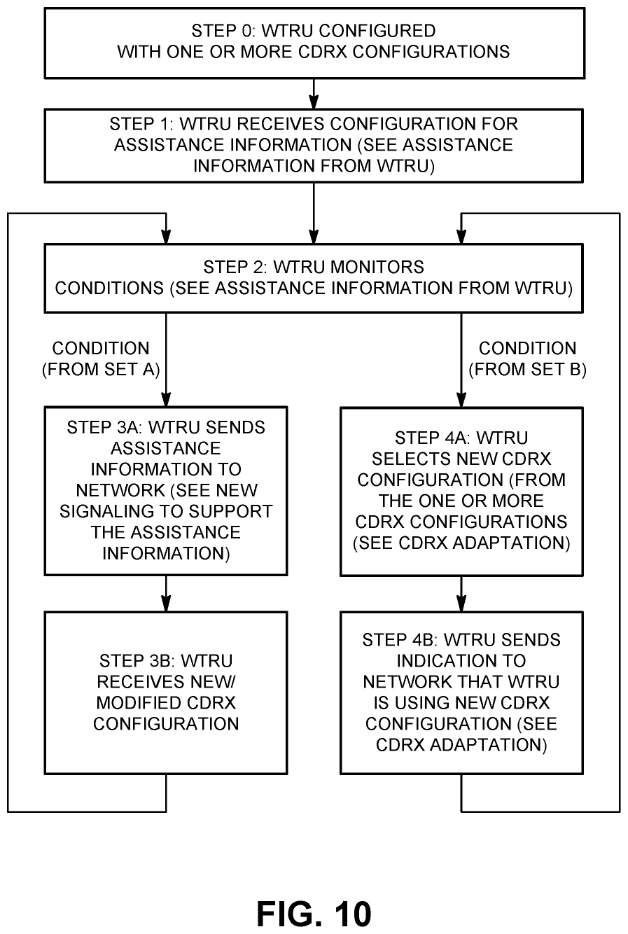

FIG. 10 illustrates an example of power savings for a WTRU. At 0, it may be assumed that the WTRU is configured with one or more CDRX configurations. RAN node may base the configuration decision on the QoS profile information received at PDU session establishment or modification. At 1, the WTRU may receive (e.g., from a network node) configuration information (e.g., via a configuration message) for the assistance information. In examples, the configuration information may include thresholds, averaging windows, timers, etc. The configuration may depend on the type of assistance information provided by the WTRU. At 2, the WTRU may monitor the conditions based on the received configuration information. These conditions may trigger certain events at the WTRU. At 3a, certain conditions (e.g., from set a) may trigger the WTRU to send assistance information to the network node. This information may allow the RAN node to determine if it needs to modify the CDRX parameters of an existing configuration, add a new CDRX configuration for the WTRU, or delete an existing configuration. At 3b, the WTRU may receive new/modified CDRX configuration from the network node. At 4a, certain conditions (e.g., from set b) may trigger the WTRU to autonomously change from one CDRX configuration to another CDRX configuration, or to change the CDRX parameters of a CDRX configuration autonomously. At 4b, the WTRU may send an indication to the RAN node that it has changed the CDRX configuration or changed a parameter of a CDRX configuration (e.g., via indicating a request to extend the CDRX active time duration (e.g., the first CDRX active time duration) by a length of time). The RAN node may subsequently acknowledge the request (e.g., confirming that the extended CDRX active time duration).

Examples of assistance information provided by the WTRU are described herein. The WTRU may provide assistance information that can be used by the network. The WTRU may monitor one or more metrics or events and send one or more types of information signals to the network. In response, the network may take some action. In examples, the network may do one or more of the following: change the CDRX configuration; change the CDRX configuration for a period of time; change the CDRX configuration until another event happens; configure multiple CDRX configurations; discard PDUs; or change the scheduling of some PDUs. If a WTRU is configured with multiple CDRX configurations, the WTRU may monitor one or more metrics or events and change from one configured CDRX configuration to another autonomously. If a certain event happens (e.g., a monitored metric is below a threshold), the WTRU may be configured to send the assistance information, to change from one configured CDRX configuration to another autonomously, or to change a parameter of a CDRX configuration. The WTRU may be configured to (e.g., alternatively) send the assistance information to the network or to change from one configured CDRX configuration to another periodically.

A type of assistance information may be the current power status. The WTRU may provide this information as a percentage of the battery level or as a relative indication of this battery level (e.g., good, medium, poor). The WTRU may be provided thresholds to determine the relative indication. The WTRU may report the power status periodically or based on some trigger event. In examples, the WTRU may report the power status if the WTRU moves from mains/wall powered to battery powered, from battery powered to mains/wall powered, or if the power status falls below a first threshold or above a second threshold.

A type of assistance information may be an indication of whether the WTRU wants the network to maximize throughput or minimize delay or maximize power savings. The RAN node actions for CDRX may depend on the WTRU preference. The WTRU may make this determination based on the priority of the traffic, current battery status, a user supplied preference received through a graphical user interface, etc.

A type of assistance information may be an indication of whether further transmissions on a QoS flow may be temporarily discarded. In examples, the WTRU may have failed to decode a video I-frame. A WTRU may not be able to decode any P or B frame based on this I-frame. The WTRU may make this determination based on an indication from the application. The application may tell the PDU layer about a missing I-frame. The WTRU may make this determination based on knowledge of which transport blocks carry I-frame information. The WTRU may determine that a transport block carrying I-frame data has failed HARQ transmission. The WTRU may make this determination based on knowledge of which RLC PDUs carry I-frame information. Based on sequence numbers, the WTRU may determine that an RLC PDU carrying I-frame information is missing. The WTRU may signal to the network to discard future PDUs on a specific QoS flow. The WTRU may specify to discard a fixed number of future PDUs received on this QoS flow. In examples, the WTRU may specify to discard future PDUs received on this QoS flow for a fixed duration. In examples, the WTRU may specify to discard future PDUs received on this QoS flow until the next I-frame is received on this QoS flow. In examples, the network may decide to autonomously stop discarding PDUs (e.g., if the network receives a PDU for this QoS flow that is an I-frame). In examples, the WTRU may indicate to the network that PDUs (e.g., all PDUs) of an identified PDU set can be discarded or the signal to the network may indicate that PDUs (e.g., all PDUs) of an identified flow of PDU sets may be discarded.

A type of assistance information may be an indication of whether the WTRU supports multiple CDRX configurations and wants to activate multiple CDRX configurations. This may allow the RAN node to configure multiple concurrent CDRX configurations for the WTRU. The WTRU may signal which QoS flows may be considered as a group for a CDRX configuration.

A type of assistance information may be an indication of how the network should deal with traffic from a QoS flow. A WTRU may prefer that the downlink traffic of a QoS flow be sent (e.g., sent only) via a single over-the-air transmission. In examples, for video traffic at 120 fps, HARQ layer retransmissions may be too slow. If an initial transmission fails (e.g., in such cases), the WTRU may request that no over-the-air HARQ retransmissions be attempted. In examples, a WTRU may prefer to minimize the transmission time of the DL transmissions. This indication may signal to the RAN node that it should try to maximize the transport block size to avoid sending the traffic over multiple transport blocks. In examples, a WTRU may signal how long traffic from a QoS flow may be delayed before transmission to WTRU. The WTRU may signal these indications as a result of dynamically changing conditions at the WTRU.

A type of assistance information (e.g., uplink extended reality media (XRM) data) may be an indication that a WTRU may remain in active time. The WTRU may send this indication (e.g., to the network node) if the power status of the WTRU changes. In examples, if the WTRU becomes mains/wall powered or the battery status crosses a (pre) configured threshold, the WTRU may signal to the network that it may stay in active mode, for example, to facilitate scheduling by the RAN node. A WTRU may send this indication (e.g., the uplink XRM data) if the WTRU has sent an uplink pose information and may be expecting an updated video frame in response. In order to meet the stringent motion-to-photon requirement (e.g., in this case), the WTRU may decide to not follow the configured CDRX and remain in active mode. The RAN node may use this information to try to schedule the updated video frame as early as possible. As part of this information, the WTRU may include the indication (e.g., the uplink XRM data) as to how long the WTRU intends to stay awake (e.g., for extending the CDRX active time duration). In examples, this may be in terms of a number of cycles, a duration in msec, a duration in symbols, a duration in slots, a duration in subframes, a duration in frames, until the start of the next cycle, or until the WTRU sends a time duration indication (e.g., another indication that the WTRU may return to following the CDRX cycle).

A type of assistance information may be an indication of whether traffic of a QoS flow is WTRU driven, server driven, or both. In examples, a WTRU driven flow may not result in significant DL traffic unless triggered by an uplink transmission. In examples, a server driven flow may not result in significant UL traffic unless triggered by an uplink transmission. A RAN node may use this information to maximize power savings if no uplink transmission may trigger any DL transmission. In examples, for the WTRU driven case, the RAN node may configure the WTRU with DRX configurations (e.g., two DRX configurations). The DRX configurations may include a first DRX configuration and a second DRX configuration. The first DRX configuration may be used when DL video traffic is expected because of uplink activity. The second DRX configuration may be used when DL video traffic is not expected. The second DRX configuration may provide more sleep opportunities and power savings for the WTRU. If the assistance information indicates that the traffic is WTRU driven, the WTRU and RAN node may use the first DRX configuration if there is uplink activity and use the second DRX configuration if there is no uplink activity.

A type of assistance information may be an indication of the traffic profile of a QoS flow. In examples, for video, the WTRU may provide an indication of the size of a GOP (number of frames between consecutive I-frames). The WTRU may provide an indication of the GOP structure, such as the number of B-frames and P-frames between I-frames. The WTRU may provide an indication of the frame rate. The WTRU may provide an indication of the size of the I-frames, B-frames, and P-frames.

A type of assistance information may be an indication about which QoS flows are linked (e.g., so that activity on one QoS flow may be linked to a second QoS flow).

A type of assistance information may be the observed jitter of generated traffic of an SDF or QoS flow. The WTRU may monitor generated traffic on SDF or QoS flow and may indicate the jitter between the arrival of a frame and the expected arrival of the frame. The indication may be an average of the jitter calculations over a window. The indication may be calculated at the PMF of the WTRU and may be sent to the network (e.g., RAN node, UPF). A RAN node may use the indication to decide to extend an active time. The RAN node may determine that most frames have a jitter of K msec. Instead of extending (e.g., always extending) the active time, the RAN node may decide to change the cycle start time to compensate dynamically.

A video frame (e.g., a single video frame) may be transmitted over multiple IP packets. As a result, the IP packets making up a video frame may be generated in bursts at a WTRU. The IP packets of a burst should be transmitted to the UPF before the next burst of IP packets.

A type of assistance information that the WTRU may provide is whether the generated PDUs of an SDF or QoS flow belong to the same burst arrival. The WTRU may tag PDUs (e.g., all PDUs) of a burst with an identifier. The identifier may be used by a RAN node or UPF to determine to discard certain PDUs of a QoS flow. In examples, a RAN node or UPF may determine to discard PDUs (e.g., all PDUs) that may be associated with the identifier (e.g., because an earlier PDU that was associated with the identifier was not successfully transmitted and the subsequent PDUs may not be useful).

Examples of assistance information provided by the UPF are described herein. The UPF may send at least the following type of assistance information to the base station to help CDRX operation.

A type of assistance information may be the observed jitter of arriving traffic on a service data flow. The UPF may monitor arriving traffic on a service data flow and may indicate the jitter between the arrival of a frame and the expected arrival of the frame. The indication may be an average of the jitter calculations over a window. This may be calculated at the PMF of the UPF and may be sent to the network RAN node or WTRU. A RAN node may use this to decide to extend an active time. The RAN node may determine (e.g., alternatively) that most frames have a jitter of K msec. Instead of extending (e.g., always extending) the active time, the RAN node may decide to change the cycle start time to compensate dynamically.

A single video frame may be transmitted over multiple IP packets. As a result, the IP packets making up a video frame may arrive in bursts at the UPF. The IP packets of a burst may be transmitted to the WTRU before the next burst of IP packets. A second type of information that the UPF may provide is whether the arriving service data flow packets belong to the same burst arrival. The UPF may tag packets (e.g., all packets) of a burst with an identifier. The indication may be used by a RAN node to discard certain packets of a QoS flow.

Examples of assistance information provided from the application server or application function are described herein. The application server may send at least the following type of assistance information to the network to help CDRX operation.

A first type of assistance information may be an indication of whether the XR application supports multiple CDRX configurations. This may allow the RAN node to configure multiple concurrent CDRX configurations for the WTRU. The application server may signal which QoS flows may be considered as a group for a CDRX configuration.

A type of assistance information may be an indication of how the network should deal with traffic from a QoS flow. An application server may signal a preference that the downlink traffic of a QoS flow be sent (e.g., sent only) via a single over-the-air transmission. In examples, for video traffic at 120 fps, HARQ layer retransmissions may be too slow. If an initial transmission fails (e.g., in such cases), the XR application may prefer that no over-the-air HARQ retransmissions be attempted. In examples, an application server may signal a preference to minimize the transmission time of the DL transmissions. This indication may signal to the RAN node that it should try to maximize the transport block size to avoid sending the traffic over multiple transport blocks. In examples, an application server may signal how long traffic from a QoS flow may be delayed before transmission to WTRU.

A type of assistance information may be an indication of whether traffic of a QoS flow is WTRU driven, server driven, or both. In examples, a WTRU driven flow may not result in significant DL traffic unless triggered by an uplink transmission. In examples, a server driven flow may not result in significant UL traffic unless triggered by an uplink transmission. A RAN node may use this information to maximize power savings if there is no uplink transmission that will trigger any DL transmission. In examples, for the WTRU driven case the RAN node may configure the WTRU with DRX configuration (e.g., two DRX configurations). The DRX configurations may include a first DRX configuration and a second DRX configuration. The first DRX configuration may be used if DL video traffic is expected because of uplink activity. The second DRX configuration may be used if DL video traffic is not expected. The second DRX configuration may provide more sleep opportunities and power savings for the WTRU. If the assistance information indicates that the traffic is WTRU driven, the WTRU and RAN node may use the first DRX configuration if there is uplink activity and use the second DRX configuration if there is no uplink activity.

A type of assistance information may be an indication of the traffic profile of a QoS flow. In examples, for video, the application server may provide an indication of the size of a GOP (number of frames between consecutive I-frames). The application server may provide an indication of the GOP structure, such as the number B-frames and P-frames between I-frames. The application server may provide an indication of the frame rate. The application server may provide an indication of the frame size distribution (of the I-frames, B-frames, and P-frames).

A type of assistance information may be an indication about which SDFs or QoS flows are linked (e.g., so that activity on one service data flow (SDF) or QoS flow may be linked to a second SDF or QoS flow).

The application server may provide the assistance information by invoking a NEF API. The NEF API may be used to provide an XRM Communication Pattern and an XRM Traffic Profile related to the XR/media service for a WTRU. The XRM Communication Pattern and XRM Traffic Profile related information may be used (e.g., may be used later) by the SMF to provide assistance to the RAN.

The procedure that is used to configure information about the XRM service may be modeled after the External Parameter Provisioning procedure.

The inputs to the NEF API may include one or more of the following: a service identifier; an XRM Communication Pattern associated with the service; or an XRM Traffic Profile that may identify if the DL traffic is WTRU driven or server driven. The XRM Communication Pattern may include at least the following information: frame rate, Group of Picture (GOP) structure, or frame size distribution. The XRM Traffic Profile may indicate if an UL transmission triggers a DL transmission from the application server. The XRM traffic profile may be a part of the XRM communication pattern.

The UDM may store the XRM Communication Pattern and the XRM Traffic Profile that is associated with the XRM service. The UDM may classify this information as “SMF associated” (e.g., following the principles of the External Parameter Provisioning procedure). The SMF may retrieve this information, combine/merge overlapping parameters for the WTRU, and derive CN assisted RAN information. The latter may be sent to the RAN node, e.g., so that it may optimize Uu resource allocation and CDRX configurations.

Examples of assistance information provided by a network data analytics function (NWDAF) are described herein. The NWDAF may (e.g., may also) provide assistance information to help CDRX operation. The NWDAF may collect information from the WTRU, UPF, RAN node, application server, and/or other network functions. The NWDAF may (e.g., may then) generate assistance information as output to provide to the network for help CDRX operation.

Typical inputs to the NWDAF may include one or more of the following: delay or jitter from the WTRU to the RAN node; delay or jitter from the RAN node to the UPF; delay or jitter from the WTRU to the UPF; delay or jitter from the UPF to the RAN node; delay or jitter from the RAN node to the WTRU; delay or jitter from the UPF to the WTRU; PDU set size (e.g., the number of PDUs in an I-frame, the number of PDUs in a B-frame, the number of PDUs in a P-frame); a measure of power savings for a WTRU (e.g., the RAN node may provide an indication of the ratio of OFF time to active time); or the RAN node or WTRU may provide the average number of HARQ transmissions for a transport block.

Typical outputs to the NWDAF may include one or more of the following: average DL jitter; average PDU set size (e.g., for I-frames, B-frames, and P-frames); GOP structure; or frame rate. These outputs may be sent to the RAN nodes to modify/add/delete CDRX configurations of a UE. These outputs may (e.g., may also) be used by the SMF to change the QoS rules provided to the WTRU, the QoS profile provided to the RAN nodes, or the SDF template provided to the UPF.

Examples of new signaling to support the assistance information may be provided herein. Based on the types of information that may be sent from the WTRU, the signaling from the WTRU may be enhanced to include one or more of the following: a power status; an indication of the WTRU preference for maximizing throughput, minimizing delay, or maximizing power savings; an indication to discard packets of a QoS flow temporarily; an indication of support for multiple DRX or single DRX; an indication of QoS flows that may be grouped for CDRX configuration; an indication to stay in active time; GOP information (size and structure); information about linked QoS flows; observed jitter for QoS flow or SDF; or an indication of whether the PDUs belong to the same burst arrival.

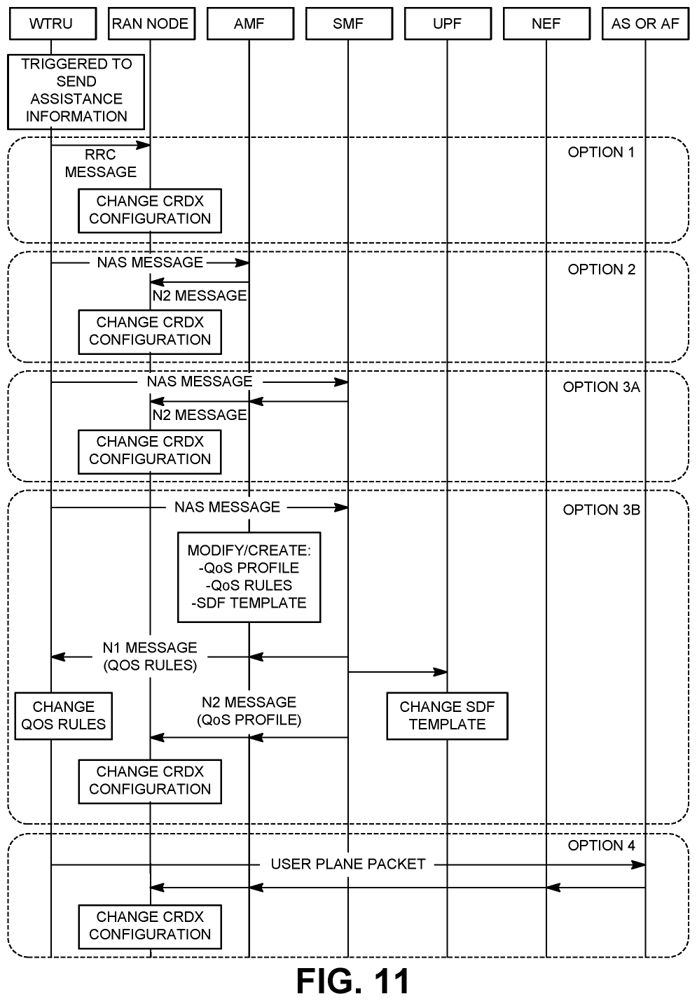

FIG. 11 illustrates an example of transmission options for assistance information from a WTRU. The assistance information from the WTRU may be sent to the network using one or more of the following transmission options. FIG. 11 shows four such options, which are described further below, including a single action taken by the network (RAN node changing CDRX configuration). This may be extended to other network actions taken at the UPFs and/or WTRU.

In a transmission option, the WTRU may provide certain types of assistance information to (e.g., directly to) the RAN node using RRC signaling. The types of assistance information may be mapped to new IEs.

In a transmission option, the WTRU may provide certain types of assistance information to the AMF over NAS signaling. The types of information may be mapped to IEs (e.g., new IEs in) an existing NAS-MM message or a new NAS-MM message.

In a transmission option, the WTRU may provide certain types of assistance information to the SMF over NAS signaling. The types of information may be mapped to IEs (e.g., new IEs) in an existing NAS-SM message or a new NAS-SM message. In examples, the information may be carried in a PDU session establishment request message or PDU session modification request message. The SMF may provide certain types of information (e.g., PDBs or adjustments to PDBs) to the RAN node through the AMF. In examples, the SMF may generate a QoS profile (e.g., a new QoS profile) or modify an existing QoS profile according to the supplied information (e.g., PDBs or adjustments to PDBs). The QoS profile is provided (e.g., then provided) to the RAN nodes by the SMF through the AMF. In examples, the SMF may generate a QoS rule (e.g., a new QoS rule) or modify an existing QoS Rule according to the supplied information (e.g., PDBs or adjustments to PDBs). The QoS rule is provided (e.g., then provided) to the WTRU through the AMF. In examples, the SMF may generate an SDF template (e.g., a new SDF template) or modify an existing SDF template according to the supplied information (e.g., PDBs or adjustments to PDBs). The SDF template may (e.g., may then) be provided to the UPF in an N4 message.

In a transmission option, the WTRU may provide certain types of information to the application server or application function over a user plane connection. The application server or application function may use the NEF to provide this information to the PCF, the AMF, or the SMF-which entity depends on the type of information. In examples, in cases where the information directly affects the CDRX configuration, this information may be provided to the AMF, which may forward it to the RAN node.

To enable some of the actions that the network may take in response to the types of information provided by the WTRU and UPF, PDU headers (e.g., new PDU headers) in the QoS flows may be required. In examples, these new headers may include one or more of the following: frame type, priority, SDF ID, or burst identifier.

For the frame type, an indication of whether the PDU being carried over the QoS flow is from an I-frame, non-I frame, B-frame, or P-frame may be included. The WTRU or UPF may make this determination based on an indication carried in the SDF PDU, which may be based on deep packet inspection of the SDF PDU, may be based on known GOP and frame timing, or may be based on a number of the SDF PDUs received. For the latter, the WTRU or UPF may assume that an I-frame may result in a significantly larger number of SDF PDUs, as compared to B and P frames.

For priority, an indication of the priority of the PDU being carried over the QoS flow may be included.

For SDF ID, an identifier for the SDF generating the PDU and being carried over this QoS flow may be included. The SDF ID may be unique within each QoS flow.

For the burst identifier, the WTRU and UPF may tag each PDU of a QoS flow that belongs to a single frame or single slice, with the same identifier. In examples, this may be a sequence number. The PDUs (e.g., all the PDUs) of one burst may have the same sequence number. The PDUs (e.g., all the PDUs) of the following burst have the next sequence number. The WTRU and UPF may determine the PDUs that belong to the same burst based on an indication carried in the SDF PDU, which may be based on deep packet inspection of the SDF PDU, may be based on known GOP, or may be based frame timing.

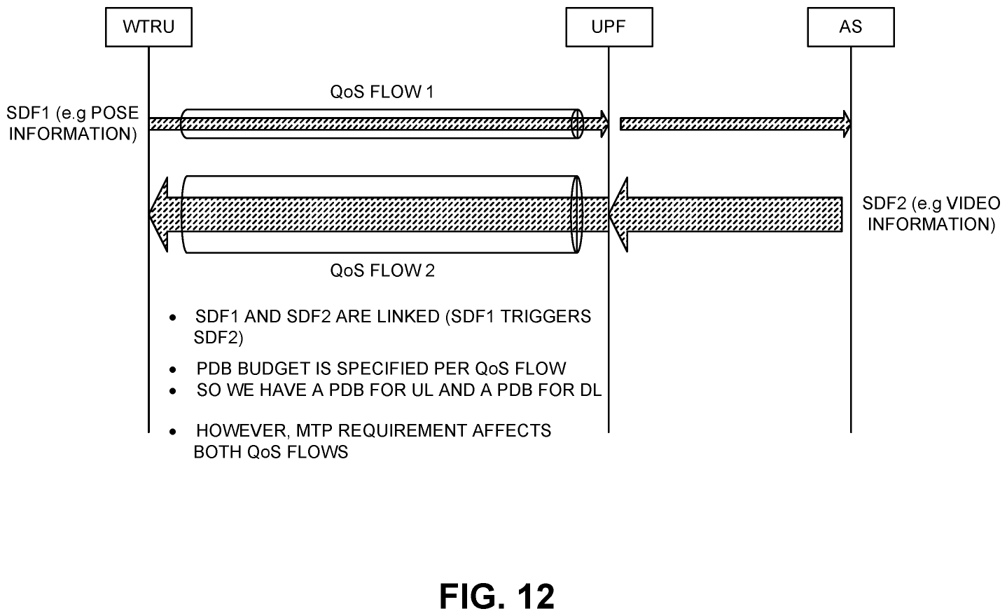

FIG. 12 illustrates an example of linked QoS flows for XR/media services. Examples related to QoS flows for XR/media services may be provided herein. XR/media services may have unique traffic characteristics and QoS requirements. This mapping of such characteristics and requirements into the QoS model (e.g., 5G QoS model) may benefit from certain enhancements. In examples, some SDFs may be linked, where traffic on one flow may trigger traffic on a second flow (e.g., the pose information on SDF1 triggers video information on SDF2, as shown in FIG. 12). As the traffic on SDFs (e.g., these two SDFs) may be quite different, these flows may be mapped to different QoS flows. The network (e.g., the 5G network) may need to treat the QoS flows (e.g., two QoS flows) together (e.g., to meet the MTP requirement for the XR/media service).

Each QoS flow may be identified by a QoS Flow Identifier (QFI), and each QoS flow may be associated with a QoS profile. The QoS profile may be used by the WTRU, the RAN node, and the UPF to determine how to treat the PDUs carried in the QoS flows. The QoS flow may be the smallest granularity over which the system (e.g., 5G system) provides QoS support. This QoS support may be based on the QoS profile associated with the QoS flow. The UPF and WTRU may both maintain a mapping of SDFs to QoS flows.

Examples of linking QoS flows may be provided. In order to link one or more SDFs, at least the following examples may be used.

In a linking example, the QoS profile may include an indication in QoS profiles (e.g., that is common to all QoS profiles) that are linked. In examples, as shown in the table below, the QoS profile may include a QoS ProfileID (QPI). QoS profiles (e.g., all QoS profiles) that are linked may share the same QPI. Network entities may know which QoS flows are linked as these QoS flows may have QoS profiles that share the same QoS ProfileID. The QoS ProFileID may be provided to the WTRU by the SMF in QoS rules and to the UPF in QoS enforcement rules.

Table 2 may provide a link method for a modified QoS profile:

| | |
|---|---|
| 5QI | Resource Type |
| | Priority Level |
| | PDB |
| | PER |
| | Maximum Burst Volume |
| | Averaging Window |
| QPI | |
| ARP | |
| RQA | |
| GFBR | |
| MFBR | |
| Session AMBR | |
| Per UE AMBR | |

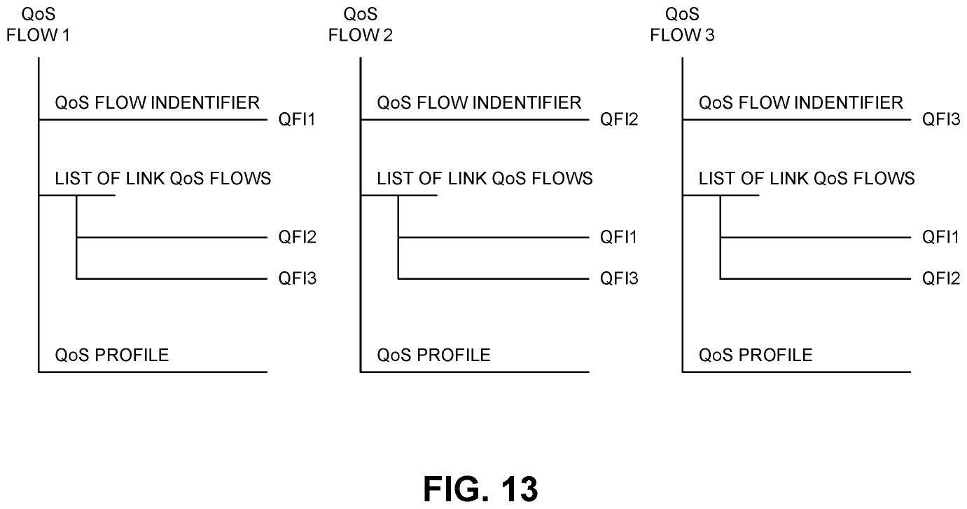

FIG. 13 illustrates an example of linked QoS flows using QFI lists. In a linking example, the QoS rules or QoS enforcement rules may have an attribute (e.g., a new attribute) that includes a list of linked QoS flows. The linked QoS flows may be identified by their QFIs. For example, FIG. 13 shows three QoS Flows, identified by QFI1, QFI2, QFI3, where all QoS flows are linked.

In a linking example, the QoS rules provided to the WTRU and the SDF template (e.g., PDRs or QoS enforcement rules) provided to the UPF may include an indication of the linked SDFs. In examples, the QoS rules may provide the WTRU with a mapping of SDFs to QoS flows. The QoS rules may be extended to include (e.g., also include) for each SDF, a list of linked SDFs. The WTRU may (e.g., may then) determine which QoS flows are linked based on the SDF to QoS flow mapping and the list of linked SDFs.

Examples of QoS parameters (e.g., new QoS parameters) in QoS profiles of XR/media services may be provided. The system (e.g., 5G system) may incorporate QoS to enhance its ability to meet the stringent QoS requirements for XR/media services. This may improve the system's ability to meet these requirements. These parameters (e.g., additional parameters) may be taken from the at least the following.

A QoS parameter for the QoS flow of XR/media services may be an indication of the type of traffic carried by the flow. In examples, this may be an indication if the traffic in the QoS flow is pose information, audio information, video information, or some other type of information. The type of traffic may (e.g., may also) be denoted through a numeric index, where the mapping of the index to the traffic type may be preconfigured in the system (e.g., 5G system). In cases where a flow carries more than one type of traffic, the indication may include a list of traffic types supported. The indication may include (e.g., alternatively) the traffic type of the highest priority. Reception or transmission of a PDU with a QoS flow ID (QFI) that indicates that the traffic is of a certain type may be any indication to the WTRU or base station that UL or DL traffic (e.g., additional UP or DL traffic) may be anticipated and therefore a CDRX configuration may be changed.

A QoS parameter for the QoS flow of XR/media services may be an indication of the direction the traffic carried by the flow. In examples, this may be an indication if the traffic is mostly from the WTRU to the UPF (UL), from the UPF to WTRU (DL), or bidirectional (from the WTRU to the UPF and from the UPF to the WTRU).

A QoS parameter for the QoS flow of XR/media services may be an indication of the priority of SDF traffic carried by the flow or priority of the type of traffic carried in the flow. This may be an indication of the relative priority of the SDF traffic or traffic type (e.g., high, low, medium). This may be a numeric indication of the priority (e.g., alternatively). In examples, a higher number may indicate a higher priority, or a lower number may indicate a higher priority.

A QoS parameter for the QoS flow of XR/media Services may be an indication of the allowed total RTT. In examples, this may refer to the time from a WTRU UL transmission to the reception of the DL transmission triggered by this WTRU UL transmission. In examples, this may refer to the sum of the PDB for a WTRU UL transmission and the PDB budget for the DL transmission triggered by this WTRU UL transmission. This QoS parameter may be relevant for linked QoS flows.

A QoS parameter for the QoS flow of XR/media services may be an indication of the preferred instantaneous block error rate (BLER) or residual BLER for transport blocks carrying the service data flow.

A QoS parameter for the QoS flow of XR/media services may be an indication of how the RAN node may treat over-the-air retransmissions for this QoS flow. In examples, the QoS parameter may specify the maximum number of over-the-air retransmissions, or it may specify that the RAN node may not allow any over-the-air retransmissions.

A QoS parameter for the QoS flow of XR/media services may be an indication of the maximum jitter allowed for the traffic of the QoS flow.

A QoS parameter for the QoS flow of XR/media services may be an indication of frame rate and GOP structure for the SDFs carrying video traffic.

Examples of round trip time (RTT) impact on linked QoS flows may be provided. In examples where the XR/media service has linked QoS flows with an RTT parameter (e.g., RTT requirement), the PDB parameter may be properly set for each of the linked QoS flows (e.g., the first QoS flow and the second QoS flow). For example, there may be a PDB for the UL traffic (e.g., a UL PDB) on (e.g., associated with) one QoS flow (e.g., a first QoS flow) and may be a PDB for the DL traffic (e.g., a DL PDB) on (e.g., associated with) the linked QoS flow (e.g., a second QoS flow) that is triggered by the uplink traffic. It may be assumed that the RTT parameter is evenly split between the PDB of both QoS flows (e.g., the UL PDB associated with the first QoS flow is equal to the DL PDB associated with the second QoS flow).

There may be an advantage to dynamically changing the PDB of the linked QoS flows (e.g., dynamically changing the UL PDB and/or the DL PDB) based on some measured packet delay of each of the linked QoS flows (e.g., the first QoS flow and the second QoS flow). In examples, if the UL packet delay is below (e.g., consistently below) the PDB (e.g., the UL PDB is too high) for the QoS flow (e.g., the first QoS flow) carrying the UL traffic, the network may reduce the PDB for this QoS flow (e.g., the first QoS flow) and may increase the PDB for the linked QoS flow (e.g., the second QoS flow) carrying the DL traffic that is triggered by the UL transmission. In examples, if the UL packet delay is above (e.g., consistently above) the PDB (e.g., the UL PDB is too low) for the QoS flow (e.g., the first QoS flow) carrying the UL traffic, the network may increase the PDB for this QoS flow (e.g., the first QoS flow) and may decrease the PDB for the linked QoS flow (e.g., the second QoS flow) carrying the DL traffic that is triggered by the UL transmission. In examples, if the DL packet delay is above (e.g., consistently above) the PDB (e.g., the DL PDB is too low) for the QoS flow (e.g., the second QoS flow) carrying the DL traffic, the network may decrease the UL PDB for the first QoS flow and may increase the PDB for the linked QoS flow (e.g., the second QoS flow) carrying the DL traffic that is triggered by the UL transmission. In examples, if the DL packet delay is below (e.g., consistently below) the PDB (e.g., the DL PDB is too high) for the QoS flow (e.g., the second QoS flow) carrying the DL traffic, the network may increase the UL PDB for the first Qos flow and may decrease the PDB for the linked QoS flow (e.g., the second QoS flow) carrying the DL traffic that is triggered by the UL transmission.

A UPF may measure the packet delay and may obtain an average packet delay for QoS flow 1 (e.g., the first QoS flow). The measurement may be made by the PMF in the UPF. The UPF may send the average packet delay measure to the SMF. If the average packet delay is below the UL PDB, the SMF may decide to reduce the PDB for QoS flow 1 (e.g., the first QoS flow) and increase the PDB for the linked Qos flow (e.g., the QoS flow 2 or the second QoS flow. The UPF or the RAN node may determine that some packets of QoS flow 1 are exceeding the PDB and are being discarded. The UPF or RAN node may send an indication of the number of discarded packets. The SMF may decide to increase the PDB for QoS flow 1 and decrease the PDB for the linked QoS flow (QoS flow 2). The WTRU, RAN node, and UPF may be notified about the changes in PDBs, so that the QoS flows may receive different QoS treatments.

A WTRU may measure the packet delay and may obtain an average packet delay for QoS flow 3. The measurement may be made by the PMF in the WTRU. The WTRU may send the average packet delay measure to the SMF via a session management (SM) message. If the average packet delay is below the PDB, the SMF may decide to reduce the PDB for QoS flow 3 and increase the PDB for the linked QoS flow (QoS flow 4). The WTRU or the RAN node may determine that some packets of QoS flow 3 are exceeding the PDB and are being discarded. The WTRU or RAN node may send an indication of the number of discarded packets to the SMF. The SMF may decide to increase the PDB for QoS flow 3 and decrease the PDB for the linked QoS flow (QOS flow 4). The WTRU, RAN node, and UPF may be notified about this change in PDB so that the QoS flows may receive different QoS treatments. The WTRU may send the SM message periodically. The WTRU may send the SM message (e.g., alternatively) if the obtained average packet delay crosses a (pre) configured threshold value, or if the number of discarded packets crosses a (pre) configured threshold value. The WTRU may send the SM message if requested by the network.

The WTRU may add markings (e.g., new markings) to the packets of a QoS flow (e.g., to assist in dynamically changing the PDB of a QoS flow). In examples, this may include a timestamp of when the packet of the QoS flow is generated. The timestamp may be added to the header of the packet. The WTRU may (e.g., may additionally) include an indication of the obtained average packet delay for a linked QoS flow. The obtained average packet delay may be added to the header of the packet. The RAN node and the UPF may use this to change the PDB of the linked QoS flows.

Information (e.g., additional information) may be added to the PDU header of linked QoS flows that have an RTT requirement (e.g., to help the system (e.g., 5G system) determine when to discard PDUs that will not be able to meet the RTT parameter associated with these linked QoS flows). The entities in the system (e.g., 5G system) (UEs, RAN nodes, or UPFs) may be able to determine if the PDU will be able to meet the RTT parameter associated with the linked QoS flows. The RTT parameter may be associated with different PDUs (e.g., two different PDUs). The two different PDUs may be PDU_1 and PDU_2. PDU_1, an ‘initiating PDU’, may be sent over one QoS flow. PDU_2, a ‘response PDU’, may be sent over a linked Qos flow. For example, a WTRU may send PDU_1 at time T1 and the RTT parameter may be set to 15 msec for the linked QoS flows. If PDU_2 arrives at the UPF at time T1+16 msec, this PDU may be too late to meet the RTT parameter. As a result, the system (e.g., 5G system) may not process this PDU, and it may be discarded. To allow the entities in the system (e.g., 5G system) to make this determination, it may be proposed that the PDU header include the time the PDU was initially generated, which may be referred to as the Round Trip Start Time (RTStartTime).

In examples, a WTRU may create PDU_1 for QoS flow 1 at time T1. The WTRU may set the RTStartTime to T1. This time may be included in the PDU header. When PDU_1 arrives at the UPF, the UPF stores the RTStartTime of PDU_1, so that it may be used for PDU_2 over the linked QoS flow. When the UPF receives traffic on the SDF of the linked QoS flow (PDU_2), the UPF may retrieve the stored RTStartTime and may include the RTStartTime in the PDU header. Based on the RTStartTime, an entity (e.g., every entity (WTRU, RAN nodes, UPFs) may determine how much time the network has left for the processing of PDU_2. That is, an entity may determine the difference between the current time (T2) and the RTStartTime (T1). If T2−T1>RTT parameter, the entity may discard the PDU. If T2−T1<RTT, then the difference (RTT−(T2−T1) may be used by the entity to tailor the treatment given to this PDU. If the difference is small, the PDU may receive some preferential treatment.

In examples, a UPF may create PDU_1 for QoS flow 1 at time T1. The UPF may set the RTStartTime to T1. This time may be included in the PDU header. When PDU_1 arrives at the WTRU, the WTRU may store the RTStartTime of PDU_1, so that it may be used for PDU_2 over the linked QoS flow. When the WTRU generates traffic on the SDF of the linked QoS flow (PDU_2), the WTRU may retrieve the stored RTStartTime and may include the RTStartTime in the PDU header. Based on the RTStartTime, an entity (e.g., every entity (WTRU, RAN nodes, UPFs)) may determine how much time the network has left for the processing of PDU_2. That is, if an entity determines the difference between the current time (T2) and the RTStartTime (T1). If T2−T1>RTT parameter, the entity may discard the PDU. If T2−T1<RTT, then the difference (RTT−(T2−T1) may be used by the entity to tailor the treatment given to this PDU. If the difference is small, the PDU may receive some preferential treatment.

Examples regarding UL active time may be provided herein. If WTRU has a PDU to transmit (e.g., as described herein), the WTRU may associate the PDU with a QoS flow and a 5QI marking. The 5QI marking may be used by the lower layers of the WTRU and the network (e.g., base station and UPF(s) to determine what QoS treatment may be required for the packet. Each 5QI may be associated with a PDB. The PDB may define an upper bound for the time that a packet may be delayed between the WTRU and the N6 termination point at the UPF. The PDB may be used to support the configuration of scheduling and link layer functions (e.g., the setting of scheduling priority weights and HARQ target operating points).

In a system (e.g., current 5G system) design, the WTRU may transmit a PDU when the PDU is ready to be transmitted unless a higher priority PDU is waiting to be transmitted. A WTRU may not buffer (e.g., delay) the PDU unless there is a higher priority PDU in the queue.

The WTRU may be configured with an UL active time that represents a time period where it may be preferred that the UE send UL data (e.g., as described herein). DL data may (e.g., may also) be periodic and the WTRU may be configured ON Duration, or active time, when the WTRU may monitor the PDCCH for DL data (e.g., as described herein). It may (e.g., may also) be preferred that the WTRU transmit UL data during the active time. Transmitting data during the active time may be preferred because it may decrease the number of WTRU wake up events. In examples, transmitting data during the active time may decrease the likelihood that the WTRU may need to wake up (e.g., wake up once) to transmit data and wake up again later to receive data.

When a PDU is received from an upper layer, the WTRU may be configured to delay, or buffer, the PDU until a preferred transmission occasion is approaching. Examples of preferred transmission occasions are the WTRU's UL active time and ON duration.

The WTRU may use the 5QI that may be associated with the PDU and the amount of time until the next preferred transmission occasion to determine whether to delay or buffer the packet. In examples, the WTRU may determine not to delay or buffer a PDU that is associated with a 5QI value of 80 (e.g., because the value 80 indicates a relatively small PDB of only 10 ms).

In examples, the WTRU may determine to delay or buffer a PDU that is associated with a 5QI value of 10 (e.g., because the value 10 indicates a relatively large PDB of only 1100 ms).

In examples, when a preferred transmission occasion is approaching in only 8 ms, the WTRU may determine to delay or buffer a PDU that is associated with a 5QI value of 79 (e.g., because the value 79 indicates a PDB of 50 ms). The WTRU may determine that the buffering delay is a sufficiently low percentage of the overall PDB.

In examples, when a preferred transmission occasion is approaching in 40 ms, the WTRU may determine to not delay or buffer a PDU that is associated with a 5QI value of 79 (e.g., because the value 79 indicates a PDB of 50 ms). The WTRU may determine that the buffering delay would be too large of a percentage of the overall PDB.

The WTRU may receive information from the network that may be used by the WTRU to determine how much of the overall PDB may be used by the WTRU to buffer a PDU to send the PDU at a preferred transmission occasion. The WTRU may use the information from the network to determine how long a packet may be buffered. The information may be a value indicating a percentage. The information may be received in a NAS-SM container in a PDU session establishment accept or PDU session modification message. The information may be associated with the QoS flows (e.g., all the QoS flows) of the PDU session or there may be separate information associated with each QoS rule of the PDU session.

The WTRU may receive delay measurements from the UPF via PMF signaling. The delay measurements may indicate the delay between the WTRU and UPF. The WTRU may use these measurements to determine how long a PDU may be buffered. In examples, the WTRU may determine that a PDU whose PDB is 50 ms may be buffered for up to 6 ms (e.g., because a delay measurement from the UPF indicates that may be likely that the PDU will experience a delay of 40 ms between the WTRU and UPF (e.g., the WTRU may assume that 4 ms may be used for extra margin).

Examples of CDRX adaptation may be provided. The WTRU may change CDRX parameters or select a CDRX configuration for (re) aligning with data transmission/reception. In examples, a WTRU may be configured with one or more CDRX configurations that may periodically change the parameters associated with a CDRX configuration or select a CDRX configuration (e.g., a new CDRX configuration) based on a realignment periodicity value. The WTRU may be configured by the network with a first configuration set (e.g., default/initial CDRX configuration and/or a default set of parameters associated with a CDRX configuration), which the WTRU may use initially when receiving the configurations (e.g., via the configuration message from the network node). The WTRU may (e.g., may also) be configured with a second configuration set (e.g., an alternative set of CDRX configurations, parameters, and/or parameter values) to which the WTRU may change periodically based on a configured realignment periodicity value. Any of the CDRX configurations or CRDX parameters may be used by the WTRU for receiving data in the DL or transmitting data in the UL in one or more data flows.

The parameters associated with a CDRX configuration configured in the WTRU may include at least one of the following: offset start time slot for starting CDRX cycle; CDRX cycle duration; on/active time duration (e.g., number of time slots/occasions the WTRU monitors for PDCCH, which the WTRU may indicate may be extended); or inactivity time duration (e.g., number of time slots/occasions the WTRU remains active after receiving PDCCH).

If changing any of the parameter values and/or CDRX configurations, the WTRU may send an indication to the network indicating at least one of the following: ID/index of the parameter, parameter value, or CDRX configuration. The WTRU may use the corresponding parameters if receiving a confirmation indication from the network node and/or after the expiration of a configured time duration. The corresponding parameters may include a second CDRX active time duration. The second CDRX active time duration may be the first CDRX active time duration extended by the requested length of time or a different CDRX active time duration than the first CDRX active time duration extended by the requested length of time. The corresponding parameters may be updated parameters (e.g., the extended first CDRX active time duration) or a second CRDX configuration (e.g., new CRDX configuration with the different CDRX active time duration). If a rejection indication is received from the network, the WTRU may fall back to using the first configuration set (e.g., default/initial CDRX configuration and/or a default set of parameters).

In examples, the parameters of the CDRX configuration may be associated with a frame rate corresponding to the data expected to be received or transmitted by the WTRU. For video data with frame rate of 60 frames per second (fps), the WTRU may be expected to receive data in the DL periodically with a periodicity value of 1/60 or 16.66 ms. For receiving such video data, the WTRU may be configured with a CDRX configuration with parameter values of 16 ms for a CDRX cycle duration and 2 ms for an on/active time duration, for example. If using such a CDRX configuration, it may be possible that after several time slots/occasions in which the WTRU may receive the data in DL during the on/active time duration, the CDRX configuration may become misaligned with respect to the frame rate (e.g., possibly due to the non-integer periodicity values corresponding to the frame rate). The WTRU may be configured (e.g., in this case) with a realignment periodicity value of 64 ms or 4 consecutive on/active time durations so that the WTRU may periodically change any of the parameters (e.g., offset start time slot or the on/active time duration) or select a second CDRX configuration (e.g., new CDRX configuration). The configured realignment periodicity may be based on assistance information, such as the frame rate.

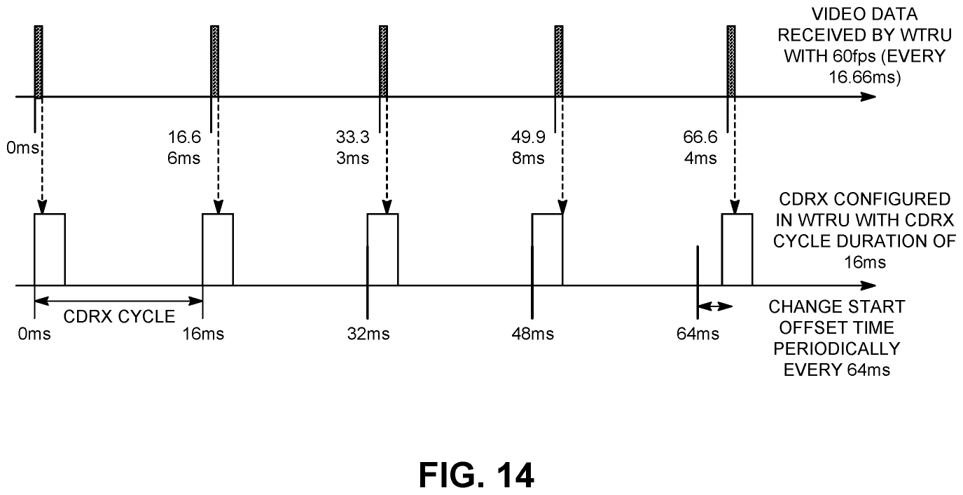

FIG. 14 illustrates an example of a WTRU configured to periodically change the start offset time for a CDRX to align with data reception based on the frame rate applied for the data. Such approaches (e.g., as illustrated in FIG. 14), may allow the WTRU to realign the reception of data with that of the frame rate when using the updated parameter values or a second CDRX configuration (e.g., new CDRX configuration).

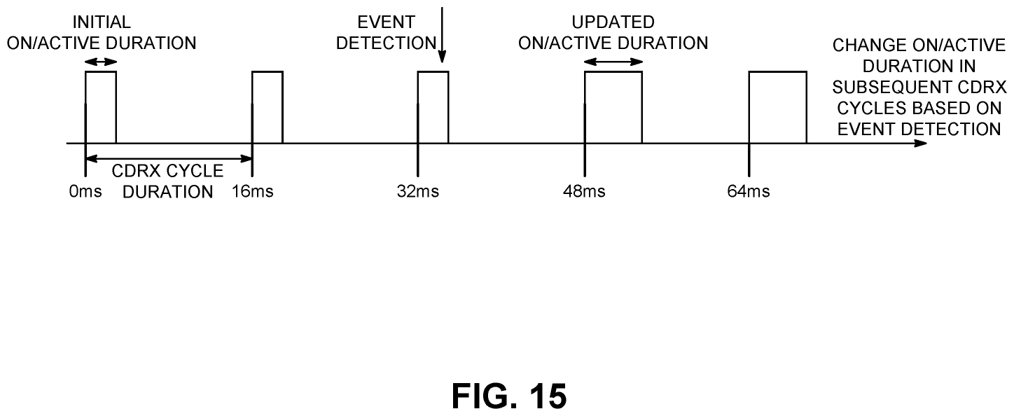

FIG. 15 illustrates an example of a WTRU changing the CDRX configuration in subsequent CDRX cycles when detecting a triggering event during a CDRX cycle. The changed CDRX configuration may result in an updated on/active time duration. In examples, the WTRU may change the parameters associated with a first CDRX configuration (e.g., initial CDRX configuration) or select a second CDRX configuration (e.g., new CDRX configuration) if detecting a triggering event (e.g., possibly at any time during a CDRX cycle). The triggering event may include one or more of the following: a connectivity/session (re) configuration; reception of a higher layer/application layer indication; changing/updating data flows per application; a measurement of jitter; a measurement of a radio link; a detection of a change in the movement of the WTRU; or a detection of a change in power status.

For the connectivity/session (re) configuration, a triggering event may be receiving or transmitting any signaling messages associated with (re) configuration of the RRC connection, RRC state, PDU session, and application layer session.

For the reception of a higher layer/application layer indication, a triggering event may be receiving an indication from a NAS layer or application hosted in the WTRU or in a network node (e.g., the property of the uplink XRM data may be indicated) indicating one or more of the following changes in the upcoming data over one or more CDRX cycles: a motion-to-photon latency (MTP) parameter; a total round trip time parameter; data type (e.g., upcoming frame changes from P/B-frame to I-frame); failed higher layer frame (e.g., the application layer has failed to decode an I-frame); traffic characteristics (e.g., number of PDUs in a PDU set may be expected to be above/below a threshold value, PDB may be expected to be above/below a threshold, frame rate increases/decreases); priority of data (e.g., priority value of PDUs or PDU sets may be expected to be above/below a threshold); or QFI or any QoS indication/marking (e.g., QFI value may be expected to be greater/lower than a threshold value).

For the changing or updating data flows per application, a triggering event may be adding one or more new flows and/or releasing existing flows associated with an application.

For a measurement of jitter, a triggering event may be when the measured jitter value (e.g., the difference between the expected time slot when data may be expected to be received and the actual time slot when data is received) in one or more data flows is above/below some threshold values.

For a measurement of a radio link, a triggering event may be when the RSRP, RSRQ, and RSSI measurements of the signals, channels, beams, carriers, links, etc. (e.g., possibly associated with the one or more data flows transmitted/received by WTRU) are above/below some threshold values.

For a detection of a change in the movement of a WTRU, a triggering event (e.g., indicated by the uplink XRM data) may be if uplink XRM data includes uplink pose information (e.g., orientation information) or if pose/positioning measurements (e.g., location information, pose in 6DoF) are above/below pose/location threshold values.

For a detection of a change in power status, a triggering event may be when the power status goes from a mains/wall to a battery. The WTRU may cap the active time to maximize power savings. For a detection of a change in a power status, a triggering event may (e.g., may also) be when the power status goes from a battery to a mains/wall. The WTRU may use a second DRX configuration with less power savings opportunities.

If changing any of the parameter values and/or CDRX configurations and/or CDRX active time, the WTRU may send an indication to the network indicating one or more of the following: ID/index of the parameter; parameter value; duration to extend the CDRX active time (e.g., first CDRX active time); or CDRX configuration. The WTRU may use the corresponding updated parameters if receiving a confirmation indication from the network and/or after the expiration of a configured time duration. The updated parameters may include a second CDRX active time duration. The second CRDX active time duration may be the first CDRX active time duration extended by the requested length of time or a different CDRX active time duration than the first CDRX active time duration extended by the requested length of time. The updated parameters may include a second CDRX configuration (e.g., new CDRX configuration). If a rejection indication is received from the network, the WTRU may fall back to using the first CDRX configuration (e.g., default/initial CDRX configuration and/or a default set of parameters). In the network response, the network may indicate to use a different ID/index of the parameter; a different parameter value; a different duration to extend the CDRX active time, or a different CDRX configuration.

In examples, the WTRU may change the parameters of a CDRX configuration, extend the first CDRX active time, or change to a second CDRX configuration (e.g., new CDRX configuration) if detecting any changes to the motion-to-photon (MTP) or RTT latency. Such MTP latency may be typically measured between the transmission of UL data during a first on/active time duration and the reception of DL data (e.g., possibly associated with UL data) during a second on/active time duration.

In examples, the WTRU may be configured by the network with one or more CDRX configurations targeting XRM services that have MTP latency requirements or RTT latency requirements. The CDRX configurations may allow the WTRU to request the network to extend the CDRX active time in order to meet the MTP latency (or RTT latency) requirements. The WTRU may (e.g., may also) be configured with MTP latency (or RTT latency) requirements of the XRM services.

The WTRU may be configured with a CDRX configuration that may allow the WTRU to request the network to extend the CDRX active time. In examples, the WTRU may determine that the uplink XRM data is from an SDF that requires low MTP latency. The WTRU may (e.g., may also) determine that the downlink XRM response is expected in the next K msec based on the configured MTP latency (or RTT latency) requirements. In examples, the WTRU may examine the header of the uplink XRM data and determine that the header includes an indication that downlink XRM data is expected in response to the uplink XRM data. The header may (e.g., may also) include an indication that the downlink data is expected within the next K msec. The K msec may be referred to as the motion-to-photon latency (MTP) parameter or a total round trip time parameter. The WTRU may determine to extend the CDRX active time duration when the MTP parameter is larger than the time remaining in the current CDRX active time. The WTRU may determine that it may not be in a CDRX active time in the next K msec and may request to extend the CDRX active time. In examples, the WTRU may determine that the current CDRX active time is expected to end in K1 msec and that the DL XRM traffic may arrive in K msec (K>K1). The WTRU may request to extend the CDRX active time for a duration of (K−K1) msec (e.g., so that the WTRU is in a CDRX active time when the DL XRM data is expected).

In examples, the WTRU may be configured by the network with one or more CDRX configurations based on the statistical information (e.g., average, standard deviation, minimum, maximum) related to MTP latency provided by WTRU in the assistance information (e.g., a property of the uplink XRM data is an MTP latency associated with the uplink XRM data) or by any of the CN entities (e.g., UPF, AMF, SMF) to the serving base station in RAN. The WTRU may (e.g., may also) be configured with one or more MTP threshold values (e.g., corresponding to maximum or minimum difference in latency from the average/expected MTP latency value) associated with a CDRX configuration, which may indicate the validity for using the CRDX configuration when transmitting and receiving data within the MTP latency.

The WTRU may be initially configured with a first CDRX configuration (e.g., an initial CDRX configuration) with a CDRX cycle duration of 16 ms (e.g., the time difference between a first time slot and a last time slot in a CDRX cycle is 16 ms) which may span and be aligned with an average MTP latency value of 17 ms. The first CDRX configuration (e.g., the initial CDRX configuration) may allow the WTRU to transmit UL data in the first time slot of the on/active duration (t1) of a CDRX cycle, transition to sleep mode after the expiration of on/active duration, and receive DL data in the first time slot of the on/active duration (t1+16 ms) of the subsequent CDRX cycle. If a CDRX is configured, the WTRU may determine the MTP latency based on the measurement of the time difference between the transmission and reception of associated data or based on another indication received from the application/NAS layer. The WTRU may compare the measured MTP latency in the CDRX cycle with respect to the configured threshold value for determining whether the CDRX configuration is valid for transmitting or receiving data in subsequent CDRX cycles. If the WTRU determines the MTP latency to be above/below a configured MTP threshold value, the WTRU may change the parameters of the first CRDX configuration (e.g., the initial CDRX configuration) or select a second CDRX configuration (e.g., new CDRX configuration) such that the data transmission/reception may be aligned with the determined MTP latency.

In examples, the WTRU may know the type of frame expected (I, B, P) based on an indication from the higher layers. If a failed transport block occurs on an I-frame, or if the higher layers indicate a failed I-frame reception, the WTRU may stop processing future receptions from the data radio bearer until receiving an indication from higher layers that the next I-frame is expected. The WTRU may (e.g., may additionally) notify the RAN node that future transmissions on this radio bearer may be suspended.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-27. (canceled)

28. A network node for managing QoS flow, comprising:
a processor configured to:
determine a round-trip (RT) latency requirement based on a quality of service (Qos) parameter;
based on the RT latency requirement, determine a first packet delay budget (PDB) value associated with a first QoS flow and a second PDB value associated with a second QoS flow, wherein the first PDB value and the second PDB value are each equal to half of the RT latency requirement;
receive, from a user plane function (UPF), a first packet delay measurement associated with the first QoS flow and a second packet delay measurement associated with the second Qos flow; and
adjust the first PDB value and the second PDB value based on at least one of the first packet delay measurement or the second packet delay measurement.

29. The network node of claim 28, wherein the processor is further configured to:
send the adjusted first PDB value and the adjusted second PDB value to at least one of: a wireless transmit/receive unit (WTRU), the UPF, or a radio access node (RAN) node.

30. The network node of claim 28, wherein the processor is further configured to:
modify at least one of a QoS profile, a QoS rule, or a service data flow (SDF) template based on the adjustment of the first PDB value and the second PDB value.

31. The network node of claim 28, wherein the processor is further configured to:
determine the first packet delay measurement is below a threshold; and
based on the first packet delay measurement being below the threshold, decrease the first PDB value and increase the second PDB value.

32. The network node of claim 28, wherein the processor is further configured to:
determine the first packet delay measurement is above a threshold; and
based on the first packet delay measurement being above the threshold, increase the first PDB value and decrease the second PDB value.

33. The network node of claim 28, wherein the processor is further configured to:
determine the second packet delay measurement is below a threshold; and
based on the second packet delay measurement being below the threshold, decrease the second PDB value and increase the first PDB value.

34. The network node of claim 28, wherein the processor is further configured to:
determine the second packet delay measurement is above a threshold; and
based on the second packet delay measurement being above the threshold, increase the second PDB value and decrease the first PDB value.

35. A method associated with network node for managing QoS flow, comprising:
determining a round-trip (RT) latency requirement based on a quality of service (QOS) parameter;
based on the RT latency requirement, determining a first packet delay budget (PDB) value associated with a first QoS flow and a second PDB value associated with a second QoS flow, wherein the first PDB value and the second PDB value are each equal to half of the RT latency requirement;
receiving, from a user plane function (UPF), a first packet delay measurement associated with the first QoS flow and a second packet delay measurement associated with the second QoS flow; and
adjusting the first PDB value and the second PDB value based on at least one of the first packet delay measurement or the second packet delay measurement.

36. The method of claim 35, further comprising:
sending the adjusted first PDB value and the adjusted second PDB value to at least one of: a wireless transmit/receive unit (WTRU), the UPF, or a radio access node (RAN) node.

37. The method of claim 35, further comprising:
modifying at least one of a QoS profile, a QoS rule, or a service data flow (SDF) template based on the adjustment of the first PDB value and the second PDB value.

38. The method of claim 35, further comprising:
determining the first packet delay measurement is below a threshold; and
based on the first packet delay measurement being below the threshold, decreasing the first PDB value and increase the second PDB value.

39. The method of claim 35, further comprising:
determining the first packet delay measurement is above a threshold; and
based on the first packet delay measurement being above the threshold, increasing the first PDB value and decrease the second PDB value.

40. The method of claim 35, further comprising:
determining the second packet delay measurement is below a threshold; and
based on the second packet delay measurement being below the threshold, decreasing the second PDB value and increase the first PDB value.

41. The method of claim 35, further comprising:
determining the second packet delay measurement is above a threshold; and
based on the second packet delay measurement being above the threshold, increasing the second PDB value and decrease the first PDB value.
